(19) United States
(12) Patent Application Publication
(10) Pub. No.: US 2025/0109586 A1
(43) Pub. Date: Apr. 3, 2025

(54) SCUTOIDAL SUB-CELL AND CELL ARRANGEMENTS

(71) Applicant: UNIVERSITY OF PUERTO RICO, San Juan, PR (US)

(72) Inventors: Marco MENEGOZZO, Mayagüez, PR (US); Andres CECCHINI BRIGI, Trujillo Alto, PR (US); Frederick A JUST AGOSTO, Mayagüez, PR (US); David SERRANO ACEVEDO, Mayagüez, PR (US)

(21) Appl. No.: 18/728,526

(22) PCT Filed: Dec. 27, 2022
(86) PCT No.: PCT/US2022/054068

§ 371 Date: Jul. 12, 2024

Related U.S. Application Data
(60) Provisional application No. 63/299,675, filed on Jan. 14, 2022.

(51) Int. Cl. E04B 1/34; F16S 1/14

(52) U.S. Cl. CPC E04B 1/34; F16S 1/14

(57) ABSTRACT

The present disclosure relates to cell geometries for use in panel designs which may allow for an increased amount of energy absorption under lateral loading, as well as axial loading. The cell geometry that may withstand more energy from different angles as compared to standard honeycomb geometry. This cell geometry may be employed as a core of repeating cells to provide an increased amount of energy absorption under lateral loading in addition to energy absorption under axial loading. The cell geometry may be composed of a portion having a squared cross-section, but with internal diagonal walls, which are neither fully parallel nor perpendicular to the cell axis. This configuration is believed to possibly increase stiffness and energy absorption of a resulting core in the lateral direction.

### RELATED APPLICATIONS

The present Application relates to and claims priority to U.S. Provisional Patent Application, Ser. No. 63/299,675, filed on Jan. 14, 2022, entitled “Scutoidal Sub-Cell and Cell Arrangements.” The subject matter disclosed in that Provisional Application is hereby expressly incorporated into the present Application.

### TECHNICAL FIELD AND SUMMARY

The present disclosure relates to cell geometries for use in panel designs which may allow for an increased amount of energy absorption under lateral loading, as well as axial loading.

Honeycomb structures are natural or man-made structures of polyhedral cells that have a honeycomb-type geometry. For man-made structures, such shapes minimize the amount of material required to reach minimal weight and minimal material cost. The geometry of honeycomb structures can vary widely, but a common feature of such structures includes an array of hollow cells formed between thin vertical walls. The cells are often columnar, cubical, or hexagonal in shape.

Man-made honeycomb structural panels are commonly made by layering a sheet of repeating honeycomb cells between two thin layers or sheets that provide strength in tension. Typically, the core of repeating honeycomb cells are sandwiched between two relatively thin plastic or metal sheets. Honeycomb materials are widely used where flat or slightly curved surfaces are needed and their high specific strength is valuable. High strength, stiffness, corrosive resistance, low weight, and minimum raw material requirement in manufacturing are just some of the advantageous characteristics of these panels.

As a result, honeycomb composite panels are widely used in the aerospace industry. Honeycomb sheets in aluminum, fiberglass, and advanced composite materials are believed to have been used in aircraft and rockets since the 1950s. They may also be found in many other fields, from packaging materials in the form of paper-based honeycomb cardboard to sporting goods such as skis and snowboards, as well as for panels used in the automotive industry.

In combination with skins applied on the top and bottom honeycomb sheet, the resulting structure is a sandwiched panel with good rigidity at minimal weight. The behavior of the honeycomb structures is orthotropic, meaning the panels react differently depending on the orientation of the structure, i.e., directions of symmetry (the length “L” and width “W” directions). The L-direction is believed to be the strongest and stiffest direction. The weakest direction is believed to be at about 60° from the L-direction (in the case of a regular hexagon) and the most compliant direction is the W-direction.

In some circumstances, however, such panels may be subject to loads containing lateral forces (i.e., in the W-direction) for which they may not be not designed. Standard hexagonal honeycomb geometries are believed to have a limited capability of absorbing energy when they experience static and impact loading conditions, especially when a significant tangential component (i.e., perpendicular to the axes of the cells-W-direction) is present. Honeycomb composite panel configurations are believed to show small energy absorption under such lateral loading. This constitutes a potential source of risk whenever a panel structure undergoes lateral loads. The low lateral and compressive strength of the honeycomb core in the direction perpendicular to the cell axes is due to the low stiffness in such direction. Accordingly, there is believed a need to develop these structures with increased energy absorption in lateral loading while still retaining high axial energy absorption loading.

An illustrative embodiment of the present disclosure provides a cell geometry. The cell geometry includes a sub-cell that is longitudinally extending along an axis. The sub-cell is composed of at least: a longitudinally extending first panel; the first panel includes a longitudinally extending first edge and a longitudinally extending second edge; a longitudinally extending second panel; the second panel includes a longitudinally extending first edge and a longitudinally extending second edge; the second edge of the first panel abuts the first edge of the second panel at a first angle to form a longitudinally extending first joint between the first panel and the second panel; a longitudinally extending third panel extends between the first panel and the second panel which forms a periphery of an open space between the first panel, the second panel, and the third panel; the third panel is triangularly-shaped and includes a longitudinally extending first edge and a longitudinally extending second edge both of which terminate and join at a first vertex; a fourth panel bounded by at least a longitudinally extending first edge, a longitudinally extending second edge, and a longitudinally extending third edge; the first edge of the fourth panel abuts the first edge of the first panel forming a longitudinally extending second joint; the second edge of the fourth panel abuts the first edge of the third panel to form a longitudinally extending third joint; and a fifth panel bounded by at least a longitudinally extending first edge, a longitudinally extending second edge, and a longitudinally extending third edge; the third edge of the fourth panel abuts the first edge of the fifth panel to form a longitudinally extending fourth joint; wherein a first end of the fourth joint terminates at the first vertex; the second edge of the fifth panel abuts the second edge of the third panel to form a longitudinally extending fifth joint; the third edge of the fifth panel abuts the second edge of the second panel to form a longitudinally extending sixth joint; and wherein a first end of the second joint, a second end of the fourth joint, and a first end of the sixth joint terminate and join at a second vertex.

In the above and other illustrative embodiments, the cell geometry may further comprise: the first panel includes a top edge, the second panel includes a top edge, and the third panel includes a top edge; the top edge of the first panel, the top edge of the second panel, and the top edge of third panel form a triangular shape oriented transverse to the axis and forms a periphery of an opening of the open space; a distal end of the sub-cell opposite the opening is the second vertex; the first angle between the first panel in the second panel is about a 90° angle; the third panel has a planar surface that is longitudinally extending parallel to the first joint; a top edge of the first panel, a top edge of the second panel, a top edge of the third panel, a top edge of the fourth panel, and the top edge of the fifth panel form an octagon shape oriented transverse to the axis and forms a periphery of an opening of the open space; a half cell formed of a planar surface of the third panel of the sub-cell and a planar surface of a third panel of a second sub-cell abut each other to form a quadrilateral polygon outer shape transverse to the axis at a top end and the second vertex of the sub-cell is spaced apart from a second vertex of the second sub-cell at an end distal from a top end of the second sub-cell; a second half cell is oriented opposite the half cell and is positioned so the second vertex of the sub-cell spaced apart from the second vertex of the second sub-cell of the second half cell are both located adjacent of the half cell to form a cell which has a quadrilateral polygon outer shape transverse to the axis along a longitudinal extent of the cell; the second half cell is identically shaped to the half cell; the first panel has a longitudinally extending planar surface, the second panel has a longitudinally extending planar surface, the third panel has a longitudinally extending planar surface, the fourth panel has a longitudinally extending planar surface, and the fifth panel has a longitudinally extending planar surface, wherein none of these planar surfaces are parallel to each other along a longitudinal extent of the sub-cell; a plurality of cells are connected to each other to form a panel; and the cell is cut transverse to the longitudinal extent such that an end profile is formed that is composed of opposing pentagonal peripheries from the half cell and opposing quadrilateral peripheries from the second half cell.

An illustrative embodiment of the present disclosure provides a cell geometry. The cell geometry includes: a sub-cell that is longitudinally extending along an axis and is composed of at least: a longitudinally extending first panel; the first panel includes a longitudinally extending first edge and a longitudinally extending second edge; a longitudinally extending second panel; the second panel includes a longitudinally extending first edge and a longitudinally extending second edge; the second edge of the first panel abuts the first edge of the second panel at a first angle to form a longitudinally extending first joint between the first panel and the second panel; a longitudinally extending third panel extends between the first panel and the second panel which forms a periphery of an open space between the first panel, the second panel, and the third panel; the third panel is triangularly-shaped and includes a longitudinally extending first edge and a longitudinally extending second edge, both of which terminate and join at a first vertex; a fourth panel bounded by at least a longitudinally extending first edge, a longitudinally extending second edge, and a longitudinally extending third edge; the first edge of the fourth panel abuts the first edge of the first panel forming a longitudinally extending second joint; the second edge of the fourth panel abuts the first edge of the third panel to form a longitudinally extending third joint; and a fifth panel bounded by at least a longitudinally extending first edge, a longitudinally extending second edge, and a longitudinally extending third edge; the third edge of the fourth panel abuts the first edge of the fifth panel to form a longitudinally extending fourth joint; wherein a first end of the fourth joint terminates at the first vertex; the second edge of the fifth panel abuts the second edge of the third panel to form a longitudinally extending fifth joint; and the third edge of the fifth panel abuts the second edge of the second panel to form a longitudinally extending sixth joint.

In the above and other illustrative embodiments, the cell geometry may further comprise: wherein a first end of the second joint, a second end of the fourth joint, and a first end of the sixth joint terminate and join at a second vertex; further comprising a half cell formed of a planar surface of the third panel of the sub-cell and a planar surface of a third panel of a second sub-cell abut each other to form a quadrilateral polygon outer shape transverse to the axis at a top end; further comprising a second half cell oriented opposite the half cell and is positioned so the second vertex of the sub-cell spaced apart from the second vertex of the second sub-cell of the second half cell are both located adjacent the half cell to form a cell which has a quadrilateral polygon outer shape transverse to the axis along a longitudinal extent of the cell; wherein a plurality of cells are connected to each other to form a panel; and the cell is cut transverse to the longitudinal extent such that an end profile is formed that is composed of opposing pentagonal peripheries from the half cell and opposing quadrilateral peripheries from the second half cell.

Additional features and advantages of this new scutoidal cell geometry will become apparent to those skilled in the art upon consideration of the following detailed descriptions of carrying out this new scutoidal cell geometry as presently perceived.

### BRIEF DESCRIPTION OF THE DRAWINGS

The concepts described in the present disclosure are illustrated by way of example and not by way of limitation in the accompanying figures. For simplicity, and clarity of illustration, elements illustrated in the figures are not necessarily drawn to scale. For example, the dimensions of some elements may be exaggerated relative to other elements for clarity. Further, where considered appropriate, reference labels may be repeated among the figures to indicate corresponding or analogous elements.

FIG. 1 is a perspective view of a scutoidal sub-cell;

FIG. 2 is another perspective view of a scutoidal sub-cell;

FIG. 3 is a top right perspective view of the scutoidal sub-cell;

FIG. 4 is a front elevational view of the scutoidal sub-cell;

FIG. 5 is another front elevational view of the scutoidal sub-cell;

FIG. 6 is a rear elevational view of the scutoidal sub-cell;

FIG. 7 is a rear perspective view of the scutoidal sub-cell;

FIG. 8 is a left side elevational view of the scutoidal sub-cell;

FIG. 9 is a rear left elevational view of the scutoidal sub-cell;

FIG. 10 is a front left perspective view of the scutoidal sub-cell;

FIG. 11 is a right side elevational view of the scutoidal sub-cell;

FIG. 12 is a front right slightly upward perspective view of the scutoidal sub-cell;

FIG. 13 is another front right side perspective view of the scutoidal sub-cell;

FIG. 14 is a top down view of the scutoidal sub-cell;

FIG. 15 is another right front side perspective view of the scutoidal sub-cell that includes reference lines;

FIG. 16 is another front left perspective view of the scutoidal sub-cell that includes reference lines;

FIG. 17 is another rear perspective view of the scutoidal sub-cell that includes reference lines;

FIG. 18 is a perspective view of a scutoidal cell;

FIG. 19 is a right side view of the scutoidal cell;

FIG. 20 is another perspective view of the scutoidal cell;

FIG. 21 is another perspective view of the scutoidal cell;

FIG. 22 is another perspective view of the scutoidal cell;

FIG. 23 is a right side elevational view of the scutoidal cell;

FIG. 24 is a perspective view of a plurality of spaced apart scutoidal sub-cells;

FIG. 25 is another perspective view of a plurality of spaced apart scutoidal sub-cells;

FIG. 26 is another perspective view of a plurality of spaced apart scutoidal sub-cells;

FIG. 27 is another perspective view of a plurality of spaced apart scutoidal sub-cells;

FIG. 28 is another perspective view of a plurality of spaced apart scutoidal sub-cells;

FIG. 29 is a perspective view of a scutoidal cell;

FIG. 30 is another perspective view of the scutoidal cell;

FIG. 31 is a perspective view of a portion of the scutoidal cell sliced about one quarter the height of a full scutoidal cell;

FIG. 32 is a top view of the scutoidal cell from FIG. 31;

FIG. 33 is a perspective view of the scutoidal cell sliced about halfway the height of a full scutoidal cell;

FIG. 34 is a top view of the scutoidal cell from FIG. 33;

FIG. 35 is a perspective view of the scutoidal cell sliced about three quarters the height of a full scutoidal cell;

FIG. 36 is a top view of the scutoidal cell from FIG. 35;

FIG. 37 is a perspective view of a panel design;

FIG. 38 is a top view of the panel design of FIG. 37;

FIG. 39 is a perspective view of another panel;

FIG. 40 is a top view of another panel design of FIG. 39;

FIG. 41 is a perspective view of a panel design;

FIG. 42 is a top view of another panel design of FIG. 41;

FIG. 43 is a perspective view of another panel design;

FIG. 44 is a top view of the panel design of FIG. 43;

FIG. 45 is a perspective view of another panel design;

FIG. 46 is a top view of the panel design of FIG. 45;

FIG. 47 is a perspective view of another panel design;

FIG. 48 is a top view of the panel design of FIG. 47;

FIG. 49 is a perspective view of another panel design;

FIG. 50 is a top view of the panel design of FIG. 49;

FIG. 51 is a perspective view of another panel design;

FIG. 52 is a top view of the panel design of FIG. 51; and

FIG. 53 is a perspective view of the interior of a scutoidal cell.

Corresponding reference characters indicate corresponding parts throughout the several views. The exemplification set out herein illustrates embodiments of the attachment assemblies and such exemplification is not to be construed as limiting the scope attachment assemblies in any manner.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The present disclosure provides an alternative honeycomb-type geometry that may improve the impact energy absorption under static and impact loads with a significant tangential component. Compared to the standard hexagonal honeycomb cells, it is believed that the innovative cell geometry disclosed herein may increase the amount of energy absorbed under lateral loading without degrading the energy absorption under axial loading.

An illustrative embodiment of the present disclosure, therefore, provides a new cell geometry that may withstand more energy from different angles as compared to standard honeycomb geometry. This cell geometry may be employed as a core of repeating cells to provide an increased amount of energy absorption under lateral loading in addition to energy absorption under axial loading. The cell geometry may be composed of a portion having a squared cross-section, but with internal diagonal walls, which are neither fully parallel nor perpendicular to the cell axis. This configuration is believed to possibly increase stiffness and energy absorption of a resulting core in the lateral direction.

Another illustrative embodiment of the present disclosure provides a scutoidal sub-cell that is composed of a top triangular cross section with depending adjacent and opposite panels meeting at a base vertex. Illustratively, the hypotenuse of the top triangular cross-section also depends therefrom forming a scutoidal panel that terminates at a scutoid vertex opposite the hypotenuse at the top triangular cross-section. Wing panels, which are illustratively triangularly shaped themselves, extend from the scutoid vertex and join to the adjacent and opposite panels meeting and terminating at the base vertex.

A plurality of these scutoidal sub-cells may be joined to form a cell that has a generally polygonal cross-section along its longitudinally extending length. For example, two scutoidal sub-cells can be joined at their respective scutoidal panels to create a first half cell with a generally polygonal cross-section (e.g., square or rectangular) at one end of the half cell and separating legs at the other end of the half cell. The scutoidal panels form a diagonal panel extending from one corner to the other of the polygonal cross-section at the one end of the half cell. A second set of joined scutoidal sub-cells forming a second half cell may be dimensioned so that its legs fit between the legs of the first half cell to form a full scutoidal cell having a generally polygonal cross-section along its longitudinal length in addition to scutoidal panels forming a diagonal panel extending from one corner to the other of the polygonal cross-section at both ends of the cell. The full scutoidal cell also includes internal diagonal panels or walls that are neither fully parallel nor perpendicular to the cell axis. It is appreciated that the lengths and widths and angles of these exterior and interior panels may be parametrically changed as needed to create various design and structural characteristics of the sub-cell, half cell, and full cell.

Further, illustratively, each full cell may be repeated to form a sheet of full cells. The sheet of full cells may be covered on top and/or below with face sheets to create a sandwich composite panel. Additionally, the sheets of full cells may be cut at different locations along the height of the sheet to create a variety of internal structural profiles of sheets of cut cells. For example, slicing a sheet of full cells at approximately one quarter height provides a different internal structural profile of each full cell of the sheet than if it were sliced at half height. Likewise, slicing the sheet of full cells at approximately three quarter height provides a different internal structural profile of each full cell of the sheet than at half height. It is appreciated that any other heights of the sheet may be chosen to create different desired internal structural profiles of the full cells. Still, further, the orientation of each cell of the sheet may be varied throughout the sheet to achieve potentially other characteristics. The square parallelepiped-shaped external geometry of the full cells makes them appropriate for tailoring the edges of square or rectangular sandwich panels and avoiding weakness points in the panels' boundaries. This may help overcome a manufacturing limitation that is encountered in standard hexagonal honeycombs. In that case, in order to produce a square or rectangular panel with straight edges, some cells may need to be cut, and this may lead to the presence of potential weakness points at the sandwich panel boundaries.

The present disclosure will be described hereafter with reference to the accompanying drawings which are given as non-limiting examples.

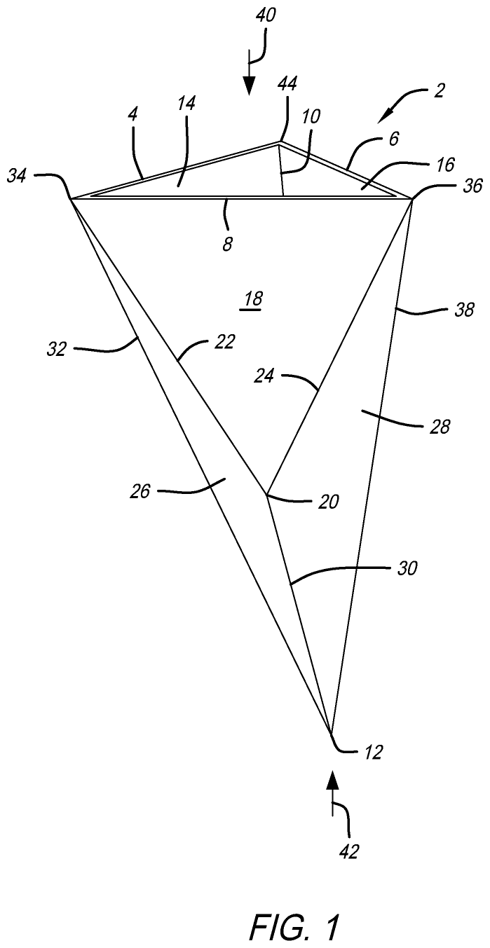

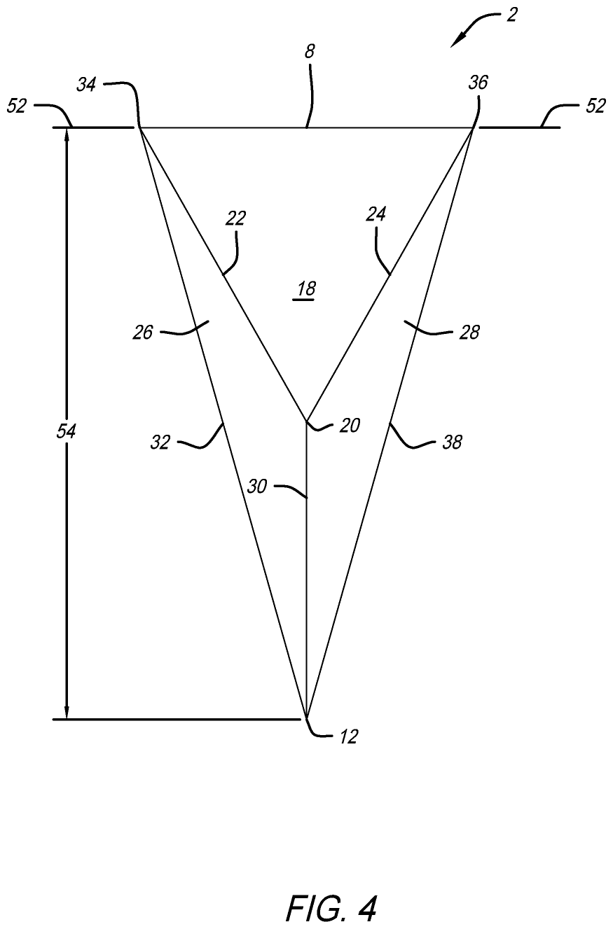

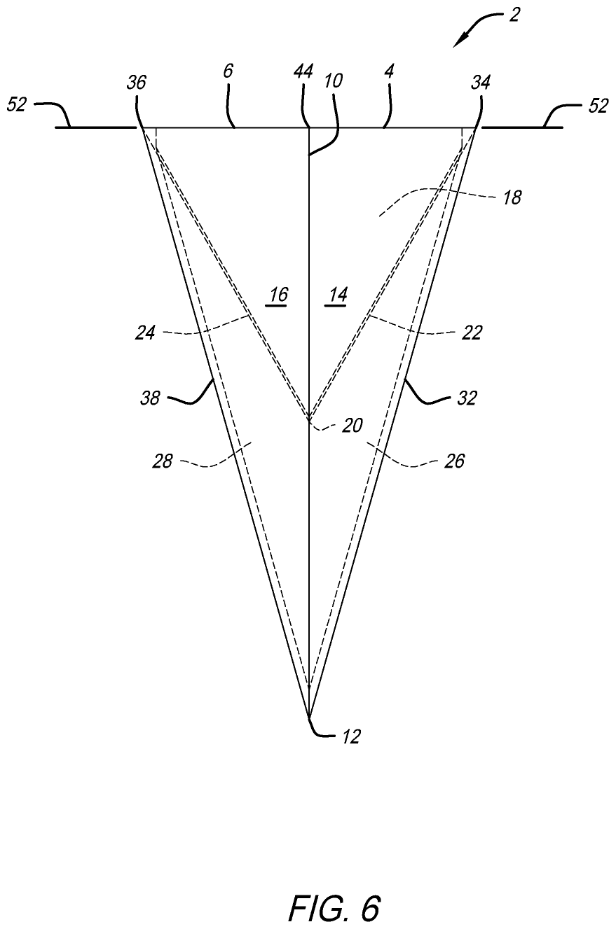

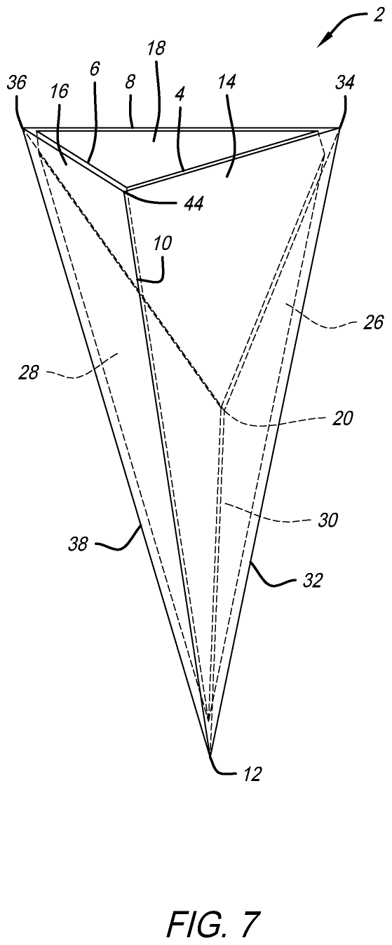

A perspective front view of scutoidal sub-cell 2 is shown in FIG. 1. The cross-sectional profile of scutoidal sub-cell 2 includes a generally triangular-shape including an opposite side 4 and adjacent side 6 joined by hypotenuse side 8. A spine joint 10 extends downwardly the height of scutoidal sub-cell 2 between opposite side 4 and adjacent side 6 to base vertex 12. The height of spine joint 10 determines the longitudinal length of scutoidal sub-cell 2 (see, also, FIG. 4). Also extending from the triangular cross-sectional end of scutoidal sub-cell 2 are opposite panel 14 and adjacent panel 16. These panels extend the longitudinal length of scutoidal sub-cell 2 and meet to form spine joint 10 as illustratively shown. Opposite panel 14 and adjacent panel 16 also terminate opposite sides 4 and 6, respectively, at base vertex 12 (see, also, FIGS. 6 and 7).

Extending downwardly from hypotenuse side 8 is a scutoidal panel 18. Unlike opposite panel 14 and adjacent panel 16, scutoidal panel 18 does not extend to base vertex 12. Instead, scutoidal panel 18 terminates at a scutoidal vertex 20 located at a different height than base vertex 12, such as that illustratively shown herein. Additionally, scutoidal panel 18 includes first scutoidal joint 22, and second scutoidal joint 24. Accordingly, scutoidal panel 18 forms an illustrative triangularly-shaped planar member extending from hypotenuse side 8 and scutoidal joints 22 and 24.

Scutoidal sub-cell 2 further includes a first wing panel 26 and second wing panel 28. Each of first and second wing panels 26 and 28, respectively, join at base vertex 12 and scutoidal vertex 20 with a wing spine joint 30 extending therebetween. With respect to first wing panel 26, it shares scutoidal joint 22 with scutoidal panel 18, as well as a longitudinally extending end joint 32 shared with opposite panel 14. Longitudinally extending end joint 32 extends between a corner joint 34 and base vertex 12. Similarly, second wing panel 28 shares longitudinally extending joint 24 with scutoidal panel 18. Longitudinally extending scutoidal joint 24 extends between scutoidal vertex 20 and corner joint 36. Second wing panel 28 also extends to a longitudinally extending end joint 38 that extends between corner joint 36 and base vertex 12, as shown. Longitudinally extending end joint 38 is also shared with adjacent panel 16 as shown. It is appreciated from these views that the top down view perspective as indicated by directional arrow 40 demonstrates that scutoidal sub-cell 2 has a different cross-sectional perspective from this view than from a bottom up view such as indicated by directional arrow 42.

It is further appreciated that the sizes of the panels herein, the angles between the joints, and distances between vertexes are illustrative. The skilled artisan upon reading this disclosure will appreciate that the dimensions can vary. Panel 16 has the shape of a rectangular triangle and constitutes portions of an external full cell wall. Exemplary dimensions of a full cell may include a height of about 2.5 inches and full cell base of about 1 inch. The angles of such triangle may include approximately or exactly 90 degrees, approximately or exactly 68.2 degrees, and approximately or exactly 21.8 degrees. However, by parametrically varying the base and height of the full cell, the values of the two latter angles vary (but remain complementary) when the other angle is approximately or exactly 90 degrees. Another illustrative size of the cell may include a height of approximately or exactly 63.5 mm (2.5 inch), a wall thickness of approximately or exactly 1.5 mm. Another illustrative size of the cell may include a height of approximately or exactly 63.5 mm (2.5 inch), a wall thickness of approximately or exactly 1.5 mm. It is appreciated that other dimensions may be applied as well.

Illustratively, each cell may be constructed of an ABS thermoplastic, other thermoplastic materials, metals, polylactic acid (“PLA”), biomaterials, wood fiber, wood fiber-reinforced PLA or other materials that can be employed to form such cell shapes. The cells can be manufactured with different base, height, and wall thickness dimensions, based on the particular application. 3D-Printing/Additive Manufacturing (AM) represents an illustrative manufacturing method since it allows it to easily reproduce a repeated number of cells with potentially thin walls, acute angles and sharp corners, and 3D printers can be quickly reset to manufacture updated geometries that are parametrically modified by varying the aforementioned geometrical sizes. Other manufacturing methods may be employed as well.

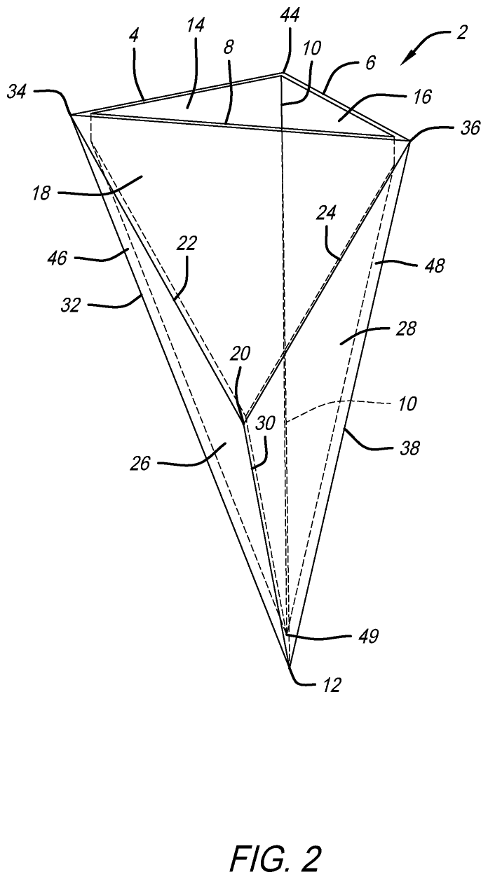

Another perspective view of scutoidal sub-cell 2 is shown in FIG. 2. This view is similar to the view of FIG. 1 except that the joints are show herein as ghost lines. For example, spine joint 10 is shown in ghost line extending downward from corner joint 44 to base vertex 12. This view also further demonstrates how opposite panel 14 and adjacent panel 16 are longitudinally extending away from sides 4 and 6, respectively, to form the longitudinal extent of spine joint 10, between corner joint 44 and base vertex 12. Additional ghost lines from this view, such as ghost lines 46 and 48, for example, indicate the thickness of the panels, in this case opposite panel 14 and adjacent panel 16. It is appreciated that ghost lines/edges 46 and 48 extend downward to join at base vertex 12 and, illustratively, joining each other at some point slightly above base vertex 12, such as at location 49 shown herein. This view demonstrates the three-dimensional structure of each of the panels that form scutoidal sub-cell 2 in addition to its structure.

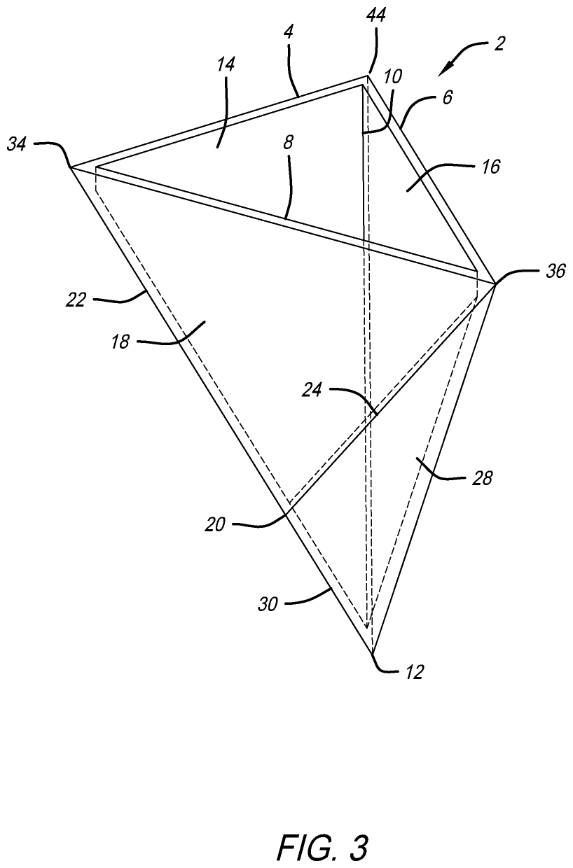

A top right perspective view of scutoidal sub-cell 2 is shown in FIG. 3. It is appreciated further from this view how the shape of scutoidal sub-cell 2 formed by the intersecting panels are not fully parallel or perpendicular to each other along the length or height of the structure. In this view, scutoidal panel 18 is shown joined to second wing panel 28 at longitudinally extending scutoidal joint 24. Because of the angle shown, first wing panel 26, which connects to scutoidal panel 18 at longitudinally extending scutoidal joint 22, is not visible. Wing spine joint 30 is visible, however, between scutoidal vertex 20 and base vertex 12. This view also shows opposite panel 14 joining adjacent panel 16 to form spine joint 10 extending between corner joint 44 and base vertex 12. Because of this perspective, however, although it may appear that opposite panel 14 joins scutoidal panel 18 along scutoidal joint 22, it does not. As shown in FIG. 2, for example, opposite panel 14 joins to first wing panel 26 along longitudinally extending end joint 32, which is not visible in this view. Such is the case when the top and bottom cross-sections of scutoidal sub-cell 2 are different as shown from perspectives 40 and 42 (see, FIG. 1).

A front elevational view of scutoidal sub-cell 2 is shown in FIG. 4. This view depicts plane 52 that is aligned with the tops of the cross-sectional profile of scutoidal sub-cell 2. Scutoidal panel 18 is shown separating portions of first wing panel 26 and second wing panel 28 at scutoidal joints 22 and 24, respectively. The triangularly-shaped profile of each of first and second wing panels 26 and 28, respectively, are also evident from this view. Wing spine joint 30 is also shown extending between scutoidal vertex 20 and base vertex 12. These structures that form scutoidal sub-cell 2 determine its height as indicated by reference numeral 54. Height 54 may also be considered the longitudinal length of scutoidal sub-cell 2. Also shown in this view are corner joints 34 and 36 with hypotenuse side 8 extending therebetween. Longitudinally extending end joints 32 and 38 of first and second wing panels 26 and 28, respectively, are also shown.

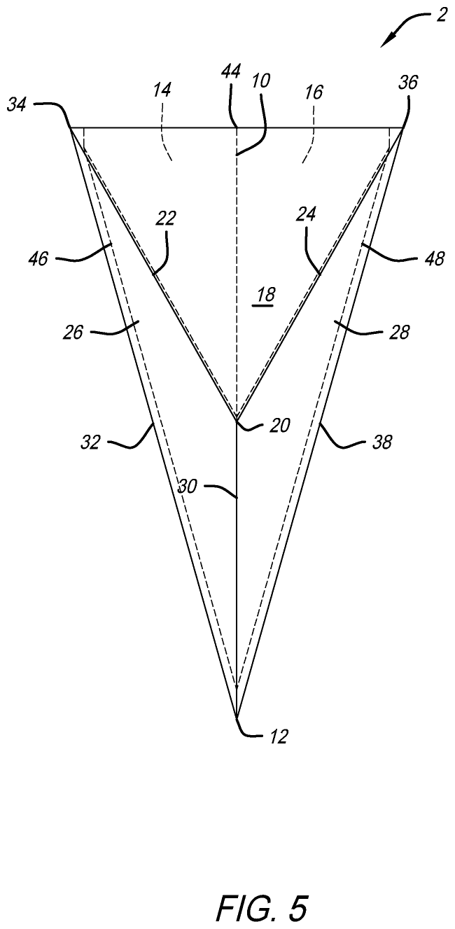

A front elevational view of scutoidal sub-cell 2, similar to that shown in FIG. 4, is shown in FIG. 5. A distinction in the views is that the thickness of opposite and adjacent panels 14 and 16 are indicated by ghost lines 46 and 48, respectively. Additionally, longitudinally extending spine joint 10 extends from corner joint 44 at the top of scutoidal sub-cell 2 down to base vertex 12.

A rear elevational view of scutoidal sub-cell 2 is shown in FIG. 6. This view depicts spine joint 10 longitudinally extending the length of scutoidal sub-cell 2, between corner joint 44 and base vertex 12. Illustratively, spine joint 10 extends about orthogonally to opposite side 4 and adjacent side 6. Further, spine joint 10 is formed between opposite panel 14 and adjacent panel 16 as shown. Opposite those panels are scutoidal panel 18, as well as first wing panel 26 and second wing panel 28. End joint 38 extends between corner joint 36 and base vertex 12 between second wing panel 28 and adjacent panel 16. Likewise, end joint 32 extends between corner joint 34 and base vertex 12 and is formed between first wing panel 26 and opposite panel 14. This view also shows scutoidal joints 22 and 24 in ghost lines extending between corner joints 34 and 36, respectively, and scutoidal vertex 20.

A rear perspective view of scutoidal sub-cell 2 is shown in FIG. 7. This view depicts opposite panel 14 extending downward from opposite side 4 and adjacent panel 16 extending downward from adjacent side 6. Opposite panel 14 joins adjacent panel 16 with longitudinally extending spine joint 10 located therebetween. Scutoidal panel 18 extends from hypotenuse side 8 to scutoidal vertex 20. As indicated by ghost lines, first wing panel 26 and second wing panel 28 join along wing spine joint 30 opposite spine joint 10. It is further appreciated from this view how first wing panel 26 is joined with opposite panel 14 along end joint 32 while adjacent panel 16 is joined with second wing panel 28 along end joint 38.

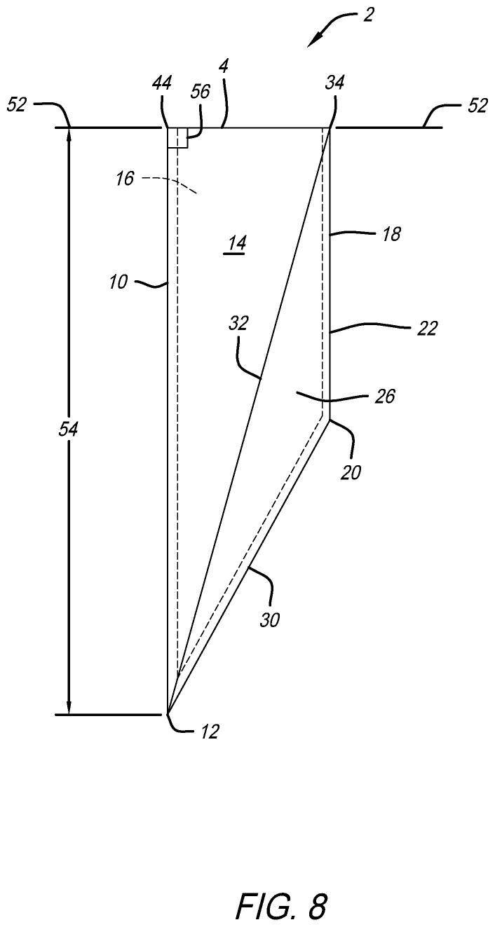

A left side elevational view of scutoidal sub-cell 2 is shown in FIG. 8. Like in FIG. 4, the view in FIG. 8 depicts scutoidal sub-cell 2 having a planar top end extending along plane 52, as well as a longitudinally extending length as indicated by height 54. From this view, it is appreciated that in the illustrative embodiment, the longitudinally extending extent of spine joint 10, joined by adjacent panel 16 and opposite panel 14, is generally orthogonal to adjacent side 6 and opposite side 4, respectively, as indicated by reference numeral 56, between corner joint 44 and base vertex 12. This means adjacent panel 16 (as well as opposite panel 14), joins with second wing panel 28 (and first wing panel 26 with respect to opposite panel 14), along end joint 38 (and end joint 32), and extends between corner joint 36 (and joint 34) and base vertex 12. Panel 16 and panel 14 have the shape of a rectangular triangle and constitute portions of an external full cell wall. By parametrically varying the base and height of a full cell, the values of the two latter angles vary (but they remain complementary, since the other angle is approximately or exactly 90 degrees). The variation of these two angles allows it to modify the orientation of the internal diagonal panels such as 18, 26, and 28, thus allowing it to tailor the load paths as a function of the loads direction in each different engineering application. Also shown in this view is scutoidal panel 18, which illustratively extends about orthogonally from plane 52 downward to scutoidal vertex 20. Scutoidal joint 22, as well as wing spine joint 30, are also shown. It is appreciated from this view, in particular, that wing spine joint 30 extends non-orthogonally to scutoidal panel 18 back to base vertex 12.

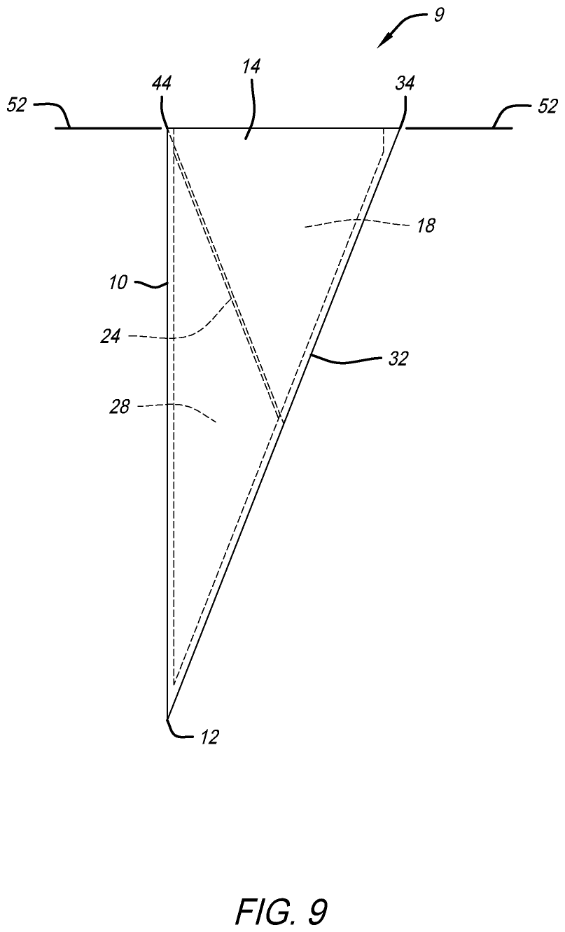

A rear left elevational view of scutoidal sub-cell 2 is shown in FIG. 9. This view shows opposite panel 14 in the foreground and scutoidal panel 18 positioned there behind. End joint 32 extending between corner joint 34 and base vertex 12 is located between opposite panel 14 and first wing panel 26 (not visible in this view). Spine joint 10 is shown extending between corner joint 44 and base vertex 12. Because of this angle, adjacent panel 16 is not visible in this view. Second wing panel 28, however, is visible in this view and shown joined with scutoidal panel 18 via scutoidal joint 24.

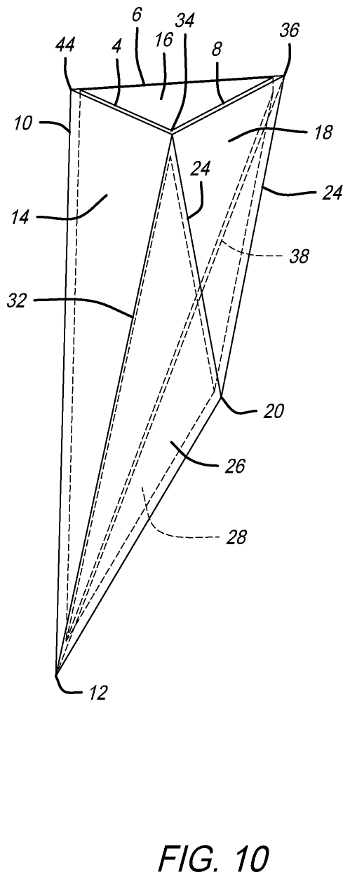

A front left perspective view of scutoidal sub-cell 2 is shown in FIG. 10. This view further depicts end joint 32 extending between corner joint 34 and base vertex 12 between opposite panel 14 and first wing panel 26. Spine joint 10 is shown extending between corner joint 44 and base vertex 12 opposite scutoidal panel 18 extending to scutoidal vertex 20. Adjacent panel 16 extends from adjacent side 6 downward to base vertex 12. End joint 38, indicated by a ghost line, extends between corner joint 36 and base vertex 12 between adjacent panel 16 and second wing panel 28. Scutoidal joints 22 and 24 are located between scutoidal panel 18 and first wing panel 26 and second wing panel 28, respectively.

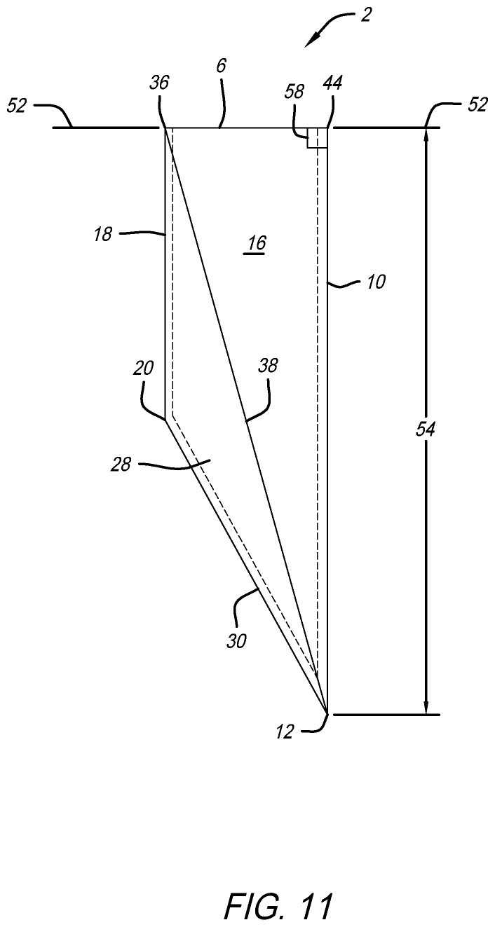

A right side elevational view of scutoidal sub-cell 2 is shown in FIG. 11. In this view, similar to that of FIG. 8, scutoidal sub-cell 2 has a top end in line with plane 52 and a longitudinally extending length indicated by height 54. In contrast to the view shown in FIG. 8, the view shown in FIG. 10 depicts adjacent panel 16 extending from adjacent side 6 between corner joints 36 and 44 and down to base vertex 12. This view further demonstrates spine joint 10 extending about orthogonally as indicated by reference number 58 with respect to plane 52 along longitudinally extending height 54 to base vertex 12. In this view, second wing panel 28 joins adjacent panel 16 along end joint 38 extending between corner joints 36 and base vertex 12. Scutoidal panel 18 is shown extending about orthogonally from plane 52 downward the length of scutoidal sub-cell 2 and terminating at scutoidal vertex 20. Wing spine joint 30, which connects second wing panel 28 with first wing panel 26 (see, also, FIG. 8), extends between scutoidal vertex 20 and base vertex 12.

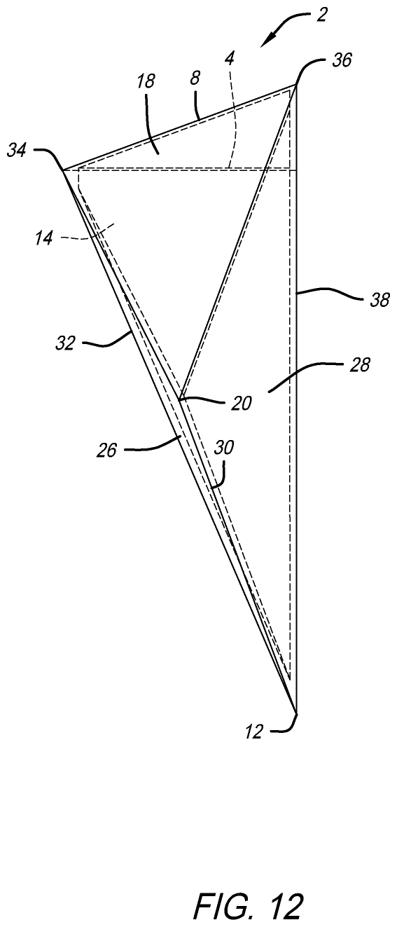

A front right slightly upward perspective view of scutoidal sub-cell 2 is shown in FIG. 12. In this view, scutoidal panel 18 is shown extending from hypotenuse side 8 down to scutoidal vertex 20. First wing panel 26 is joined to second wing panel 28 at wing spine joint 30 extending between scutoidal vertex 20 and base vertex 12. End joint 32 extends between corner joint 34 and base vertex 12 and connects to opposite panel 14. Also shown is opposite side 4. End joint 38 is also shown extending from corner joint 36 to base vertex 12 between second wing panel 28 and adjacent panel 16 (not visible in this view).

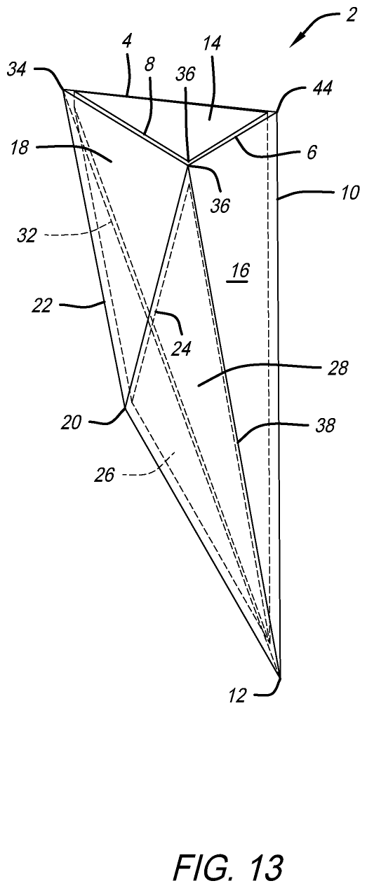

Another front right side perspective view of scutoidal sub-cell 2 is shown in FIG. 13. This view further depicts the orthogonal orientation of spine joint 10 extending from corner joint 44 to base vertex 12 with respect to opposite side 4, adjacent side 6 and hypotenuse side 8. Also shown are opposite panel 14 and adjacent panel 16 extending the longitudinal length of scutoidal sub-cell 2 joining to form spine joint 10. Scutoidal panel 18 likewise extends downwardly from hypotenuse side 8 and terminates at scutoidal vertex 20. Scutoidal joints 22 and 24 are shown connecting scutoidal panel 18 to first wing panel 26 and second wing panel 28. End joint 32, shown in ghost line in this view, connects first wing panel 26 to opposite panel 14 between corner joint 34 and base vertex 12. Similarly, end joint 38 extends between corner joint 36 and base vertex 12 between second wing panel 28 and adjacent panel 16.

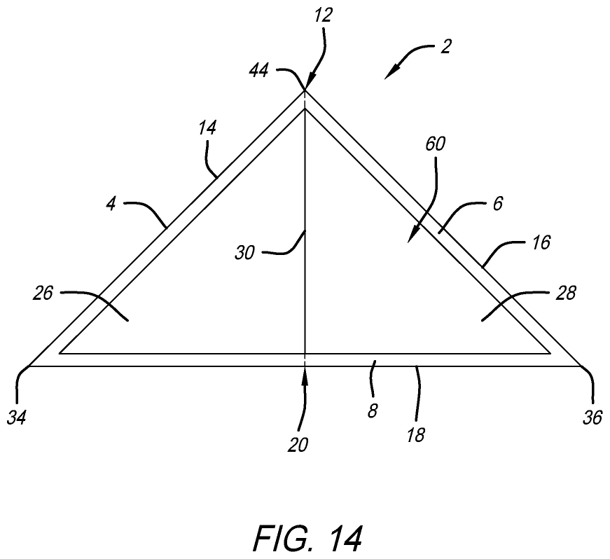

A top down view of scutoidal sub-cell 2 is shown in FIG. 14. This view, in particular, demonstrates the triangularly-shaped cross-section of scutoidal sub-cell 2 formed from opposite side 4, adjacent side 6, and hypotenuse side 8. Also shown are corner joints 34, 36, and 44. Because of the open space 60 within scutoidal sub-cell 2, wing spine joint 30 is shown extending from front to back of scutoidal sub-cell 2. It is appreciated that wing spine joint 30 extends between scutoidal vertex 20 and base vertex 12, both located behind the shown cross-section view. Scutoidal panel 18 extends from hypotenuse side 8, while opposite panel 14 extends from opposite side 4 and adjacent panel 16 extends from adjacent side 6. Inside open space 60, first wing panel 26 and second wing panel 28 are visible forming wing spine joint 30 therebetween.

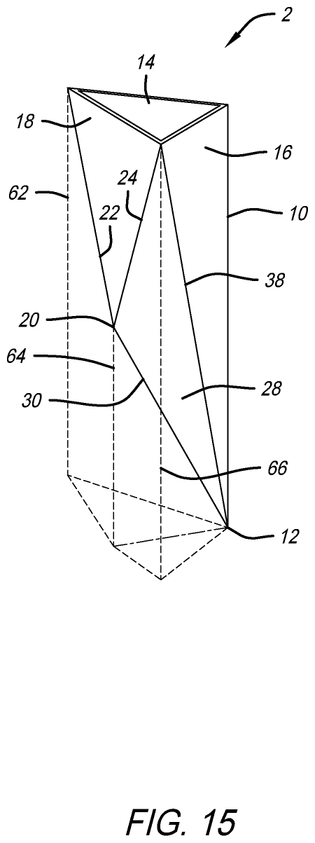

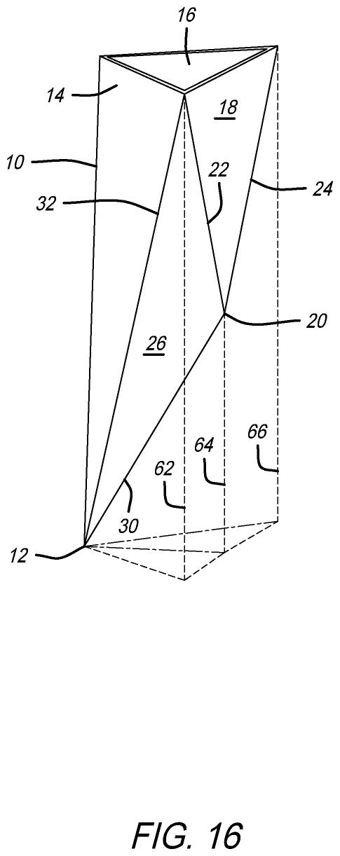

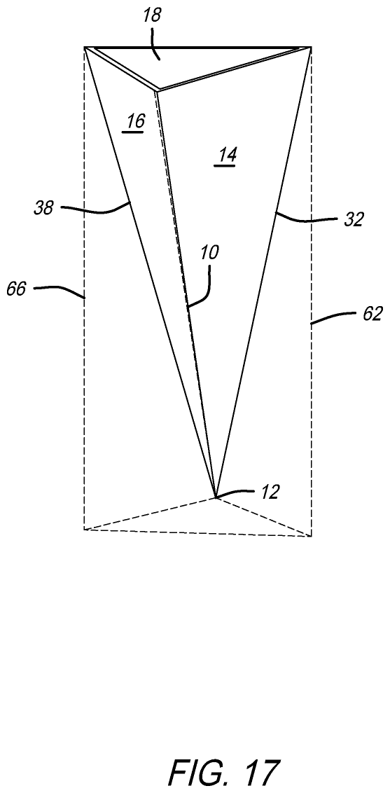

The views of FIGS. 15, 16, and 17 are similar to views of FIGS. 13, 10, and 7, but include reference lines 62, 64, and 66 orthogonally positioned with respect to plane 52. These views assist in further appreciating the non-perpendicular angles of certain panels such as first and second wing panels 26 and 28. In addition, the views, likewise, demonstrate how the panels are joined in non-parallel and non-perpendicular manner at joints 22, 24, 38, and 30, all of which, except for joints 22 and 24, terminate at base vertex 12. Joints 22 and 24 terminate further up along the longitudinal length of scutoidal sub-cell 2 at scutoidal vertex 20. The angles these panels can be oriented at with respect to each other are not independent variables, but are rather the result of the parametric values (i.e., length) chosen for the cell width (edges 4 and 6) and for the cell height (edge 10), that may be the same for each of the four sub-cells constituting a full cell. The resulting orientation of panels 18, 26 and 28 makes it possible to combine four sub-cells to have a parallelepiped-shaped full cell, and constitute the internal diagonal walls that may determine an increased energy absorption and stiffness under lateral loads.

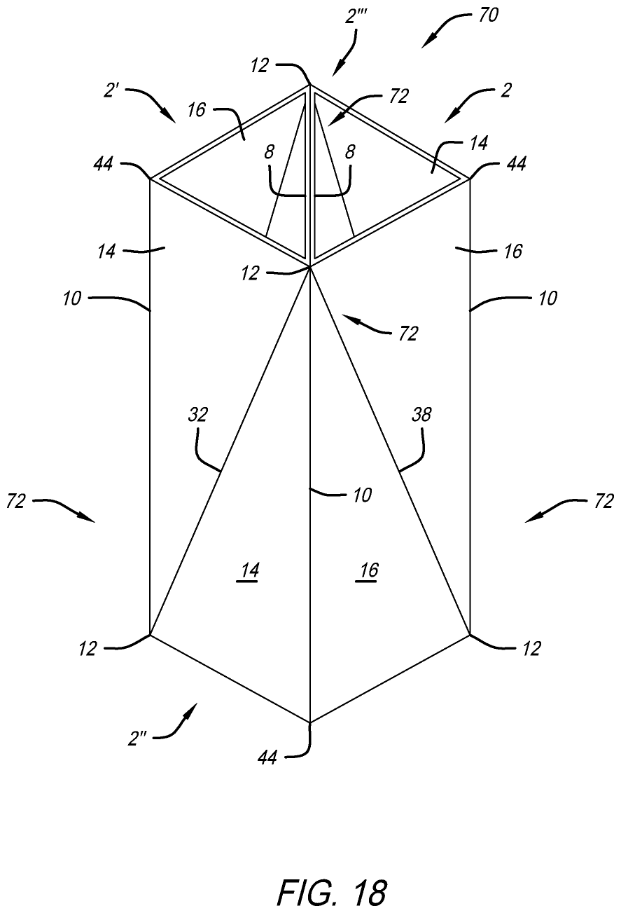

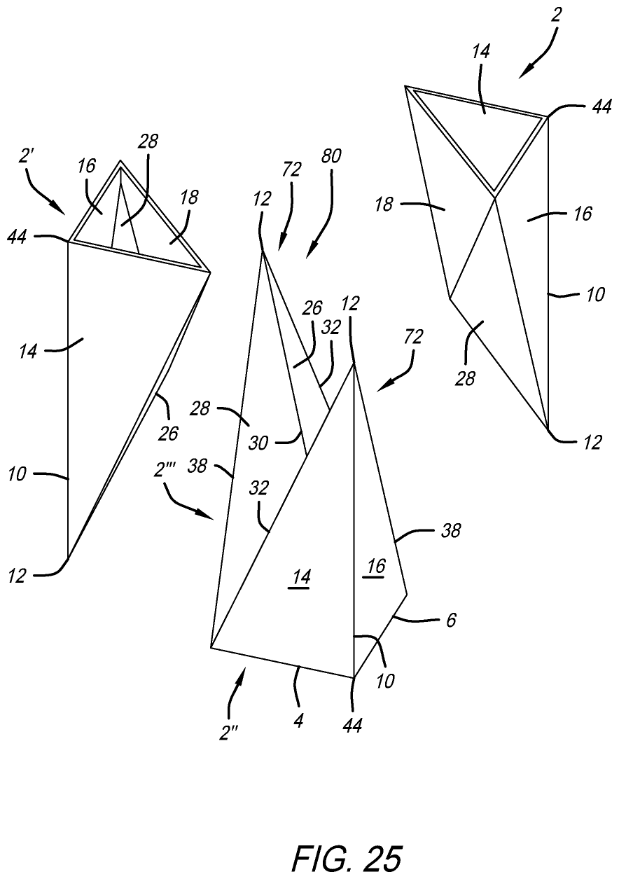

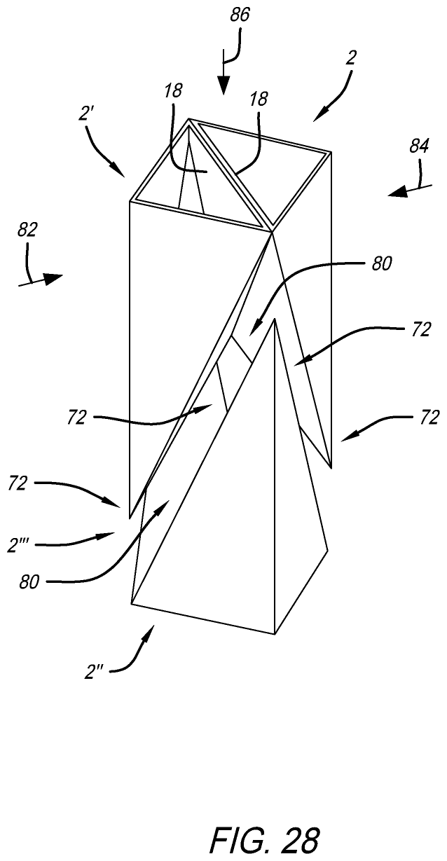

A perspective view of a scutoidal cell 70 is shown in FIG. 18. This illustrative embodiment of scutoidal cell 70 may be illustratively polygonal-such as square or rectangular cross-sectionally shape and longitudinally extending as shown. Here, scutoidal sub-cells 2, 2′, 2″, and 2′″ are joined to compose this polygonal or cube-shaped cell. In this case, the top triangularly shaped cross-section portions of scutoidal sub-cells 2 and 2′ are joined at hypotenuse side 8 so that the respective scutoidal panels 18 abut each other to form a top half of scutoidal cell 70 (see, also, FIG. 28). Each of scutoidal sub-cells 2 and 2′ form spaced legs 72 on the outer surfaces of which are formed by opposite panel 14 and adjacent panel 16. Two of the corners of cube scutoidal cell 70 are formed via spine joint 10 extending between respective corner joints 44 and base vertex 12 on each of scutoidal sub-cells 2 and 2′. In order to form a full scutoidal cell 70, two additional sub-cells 2″ and 2′″ are likewise joined at their respective scutoidal panels 18 to form spaced legs 72 like that previously discussed with respect to scutoidal sub-cells 2 and 2′ (see, also, FIGS. 25-28). In contrast to scutoidal sub-cells 2 and 2′, however, scutoidal sub-cells 2″ and 2′″ are oriented upside down with respect to scutoidal sub-cells 2 and 2′. All of the sub-cells are joined to form the opposing corners of the cube structure of scutoidal cell 70. With respect to scutoidal sub-cell 2″, its panels 14 and 16 form spine joint 10 extending between corner joint 44 and base vertex 12. Here, end joint 38 also forms a seam between respective adjacent panel 16 to from scutoidal sub-cell 2 and scutoidal sub-cell 2″. Similarly, end joint 32 forms a seam between opposite panels 14 of scutoidal sub-cell 2′ and 2″, respectively. The same is the case with the joints and panels between scutoidal sub-cell 2″ and scutoidal sub-cells 2 and 2′.

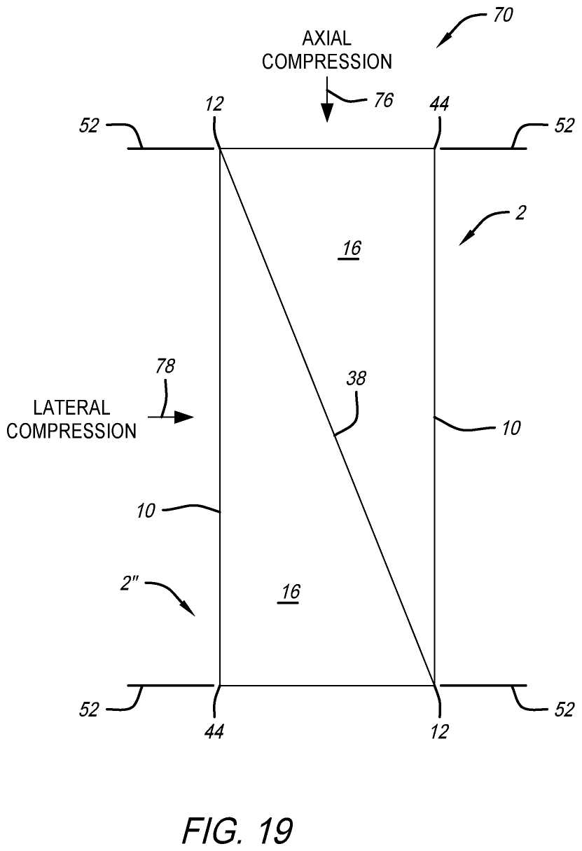

A right side view of scutoidal cell 70 is shown in FIG. 19. Here, adjacent panel 16 of scutoidal sub-cell 2 is shown adjacent the adjacent panel 16 of scutoidal sub-cell 2″ with joint 38 being a seam between respective base vertexes 12. Opposing corners of the cube shape of scutoidal cell 70 are respective spine joints 10 extending between corner joints 44 and base vertexes 12 of respective scutoidal sub-cells 2 and 2′. It is appreciated that each end of scutoidal cell 70 has a polygonal cross-section forming planes 52 as illustratively shown. Also shown in this view is axial compression force 76 that may act along the longitudinal extent of scutoidal cell 70. In contrast, lateral compression force 78 may act perpendicular to axial compression force 76 transverse to the longitudinal extent of scutoidal cell 70, as shown. Because of the angular panels within scutoidal cell 70, increased lateral compression is believed to be withstood. Forces 76 and 78 are here represented as compressive forces, but they may also stand for tangential forces acting parallel to plane 52 and/or parallel to the full cell's lateral faces/height/joint 10.

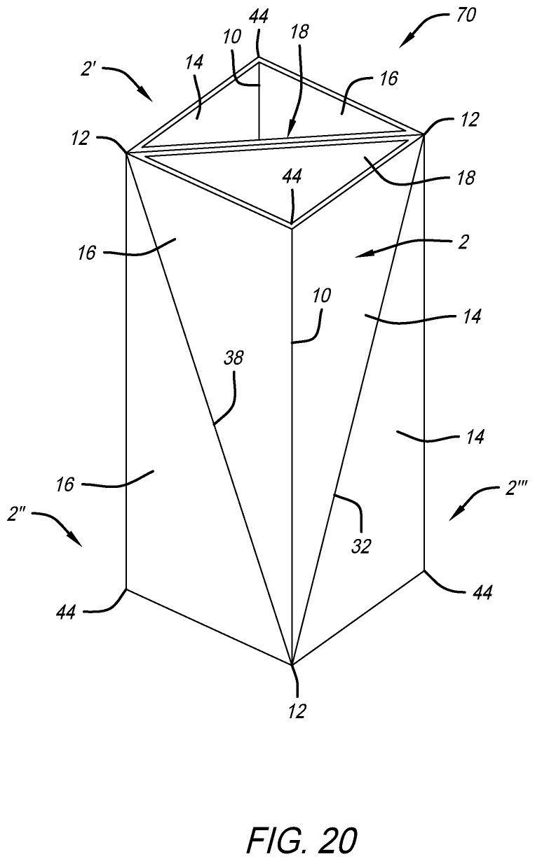

Another perspective view of scutoidal cell 70 is shown in FIG. 20. This view is similar to that of the perspective view of scutoidal cell 70 of FIG. 18, but now rotated approximately or exactly 90°. As shown here, scutoidal panels 18 of scutoidal sub-cells 2 and 2′, respectively, are joined. Spine joints 10, on each of scutoidal sub-cells 2 and 2′, again, form outer corners of the cube shape of scutoidal cell 70. Opposite and adjacent panels 14 and 16, respectively, from each of scutoidal sub-cells 2 and 2′, form portions of the outer walls of scutoidal cell 70.

In order to form the full cube shape of scutoidal cell 70, and as previously discussed, scutoidal sub-cells 2″ and 2′″ are positioned opposite scutoidal cells 2 and 2′ and joined as shown. In this view, adjacent panels 16 of scutoidal sub-cells 2 and 2″ form an outer wall of scutoidal cell 70 with joint 38 extending between base vertexes 12 as a seam on the surface of scutoidal cell 70. Likewise, opposite panels 14 from each of scutoidal sub-cells 2 and 2″ join to form and outer wall of scutoidal cell 70 with joint 32 extending between base vertexes 12 and forming a seam in the outer wall of scutoidal cell 70. It is appreciated that the same occurrence between scutoidal sub-cell 2′ and scutoidal sub-cells 2″ and 2′″ form the remainder of the outer walls of the cube shape of scutoidal cell 70.

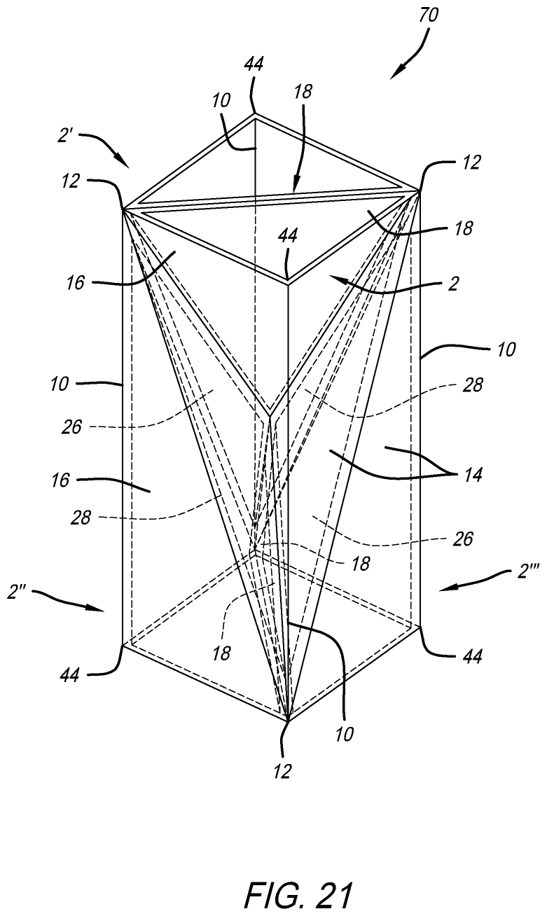

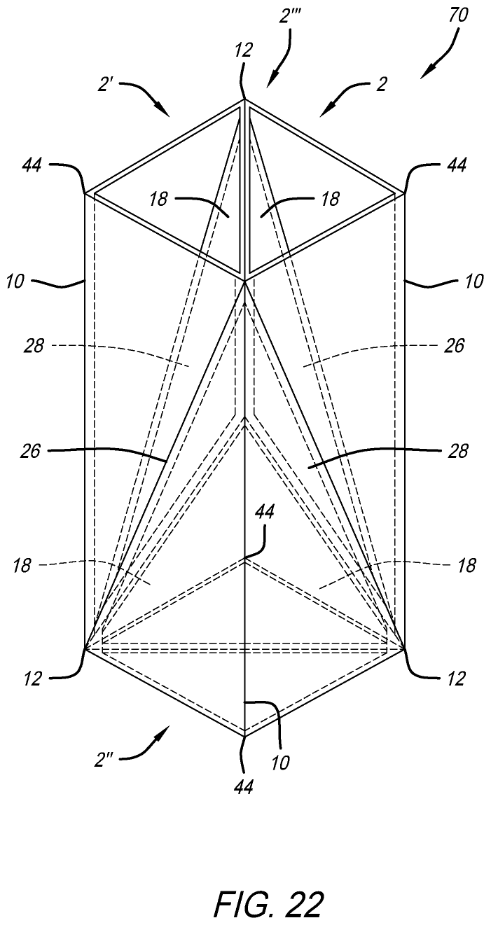

Perspective views of scutoidal cell 70 are shown in FIGS. 21 and 22. These views are substantively the same as the views in FIGS. 20 and 18, respectively, except that here the geometry of the interior walls formed by scutoidal sub-cells 2, 2′, 2″, and 2′″ are visible by ghost lines. The internal diagonal panels inside scutoidal cell 70 may provide additional stiffness and energy absorption under lateral loads, thanks to the load paths that they provide for lateral loads. By varying the height and width of scutoidal cell 70, the inclination of the internal diagonal walls vary, and such inclination can be tuned/tailored so as to withstand each particular load scenario. This way, the inclination/orientation of the internal diagonal walls may be designed based on the anticipated direction and inclination angle(s) of the external acting load(s).

Similar to the view shown in FIG. 20, scutoidal cell 70 is composed of scutoidal sub-cells 2, 2′, 2″, and 2′″ as shown. The exterior walls forming the cube of scutoidal cell 70 are composed of opposite panels 14 and adjacent panels 16 from the sub-cells. Spine joints 10 form the outer corner edges of the cube-shape of scutoidal cell 70. Likewise, corner joint 44, or base vertex 12, form end corners of scutoidal cell 70 as well. Inside scutoidal cell 70 are two abutting or mating scutoidal panels 18 from scutoidal sub-cells 2, and 2′. First wing panel 26 and second wing panel 28 of both scutoidal sub-cells 2, and 2′ are also shown. The interior geometry of scutoidal cell 70 further shows abutting scutoidal panels 18 of scutoidal sub-cells 2″ and 2′″. In this illustrative embodiment, these scutoidal panels 18 are positioned below and oriented perpendicular to the abutting scutoidal panels 18 of scutoidal sub-cells 2, and 2′. Also, though not fully visible in this view, first wing panel 26 and second wing panel 28 of scutoidal sub-cells 2″ and 2′″ mate with the corresponding wing panels of scutoidal sub-cells 2 and 2′. This internal geometry is believed to provide additional strength because the three internal diagonal panels 26 and 28 of each sub-cell are neither parallel to plane 52 nor perpendicular to it, and diagonal panel 18 is inclined by approximately or exactly 45 degrees with respect to each of panels 14 and 16, which allows it to increase the compressive strength along multiple directions, including lateral and axial. Again, the internal diagonal panels inside scutoidal cell 70 may provide additional stiffness and energy absorption under lateral loads, thanks to the load paths that they provide for lateral loads. By varying the height and width of scutoidal cell 70, the inclination of the internal diagonal walls vary, and such inclination may be tuned/tailored so as to withstand each particular load scenario. This way, the inclination/orientation of the internal diagonal walls may be designed based on the anticipated direction and inclination angle(s) of the external acting load(s).

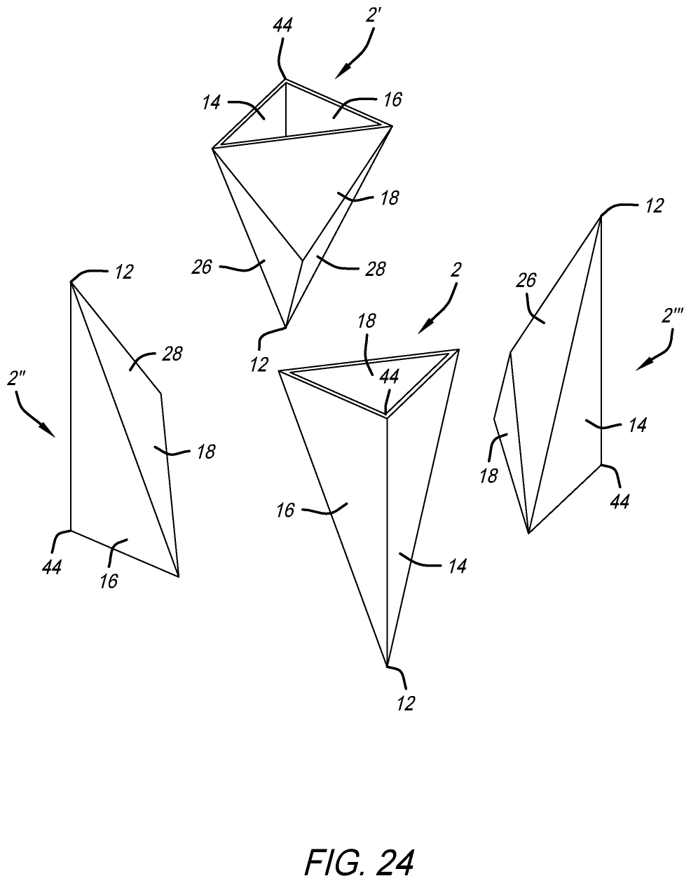

Another perspective view of scutoidal cell 70, similar to that shown in FIG. 18, is shown in FIG. 22. Here, however, the geometry of the internal structures of the individual scutoidal sub-cells are shown. Scutoidal panels 18 of scutoidal sub-cells 2 and 2′ are shown mated together at the top half of scutoidal cell 70, while scutoidal panels 18 from scutoidal sub-cells 2″ and 2′″, are mated and oriented perpendicularly to the scutoidal panels 18 of scutoidal sub-cells 2 and 2′ at the lower portion of scutoidal cell 70. Further shown in this view are first wing panel 26 and second wing panel 28 of scutoidal sub-cell 2″ and first wing panel 26 and second wing panel 28 of scutoidal sub-cell 2″. These wing panels will be positioned adjacent or abutting to corresponding wing panels from scutoidal sub-cells 2 and 2′ as further discussed with respect to FIGS. 24-29. Scutoidal panels 18 are illustratively exactly or approximately perpendicular to plane 52 and inclined by exactly or approximately 45 degrees with respect to each of opposite and adjacent panels 14 and 16.

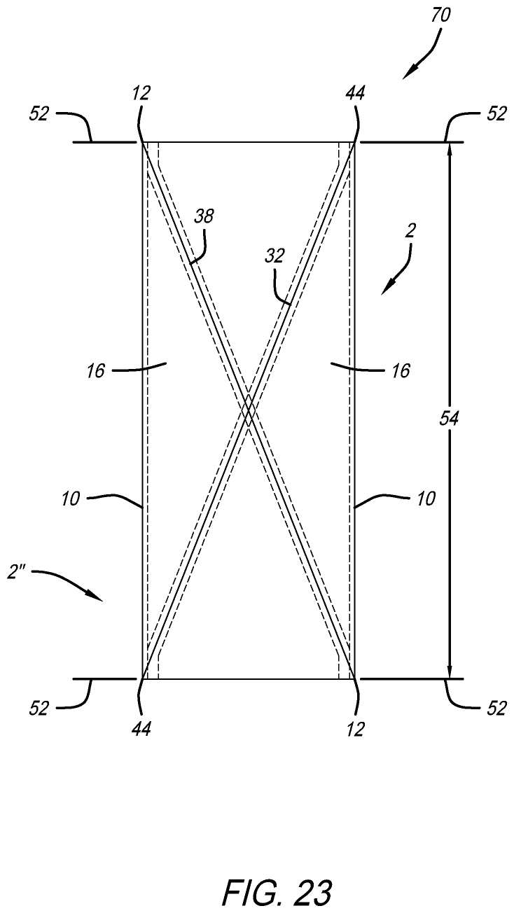

A right side elevational view of scutoidal cell 70 is shown in FIG. 23. From this view, it is appreciated how the cross-section ends of scutoidal cell 70 are aligned with planes 52 as shown. Scutoidal cell 70 also has height 54 as previously discussed with respect to scutoidal sub-cell 2 in FIG. 4. This view shows adjacent panels 16 mating scutoidal sub-cell 2 with scutoidal sub-cell 2″ with end joint 38 forming a seam therebetween. On the opposite side is end joint 32 extending between adjacent panels 16 of scutoidal sub-cell 2′ and scutoidal sub-cell 2″ (not visible in this view, see, FIG. 18).

Progression views depicting how scutoidal sub-cells 2, 2′, 2″, and 2′″ are brought together to form a single scutoidal cell 70 are shown in FIGS. 24, 25, 26, 27, 28, 29, and 30. In these perspective views, scutoidal sub-cells 2, 2′, 2″, and 2′″ are shown facing each other to be formed into scutoidal cell 70. As shown herein, scutoidal sub-cells 2 and 2′ face each other while scutoidal sub-cells 2″ and 2′″ face each other therebetween. It is contemplated that scutoidal panels 18 from scutoidal sub-cells 2 and 2′ are configured to mate or abut each other. Scutoidal panels 18 from scutoidal sub-cells 2″ and 2′″ will likewise mate or abut each other. Additionally, base vertexes 12 of scutoidal sub-cells 2 and 2′ are directed downwardly while base vertexes 12 of scutoidal sub-cells 2″ and 2′″ are directed upwardly.

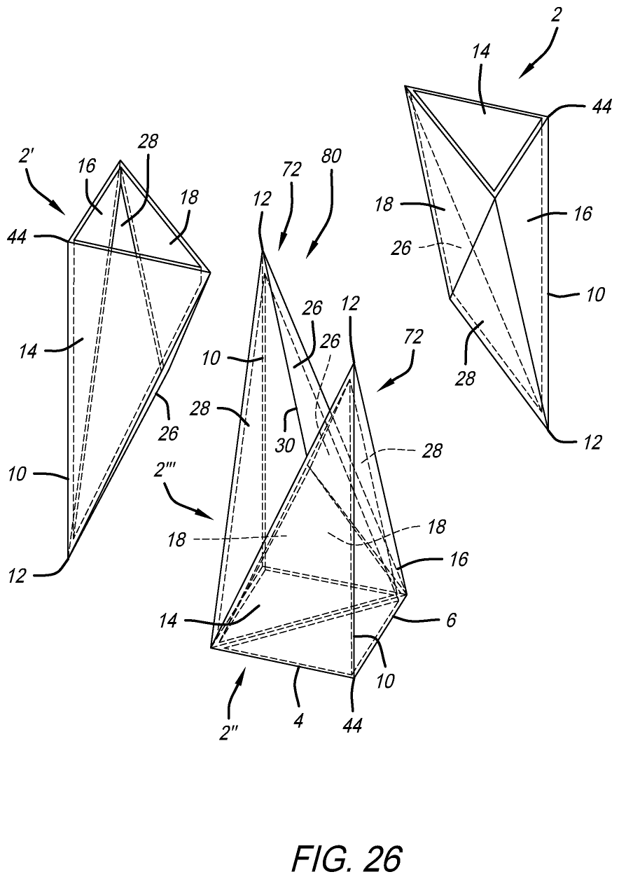

A perspective view of scutoidal sub-cells 2, 2′, 2″, and 2′″ rotated from the view shown in FIG. 24 and with scutoidal sub-cells 2″ and 2′″ mating each other is shown in FIGS. 25 and 26. These views depict scutoidal panels 18 of scutoidal sub-cells 2″ and 2′″ abutting each other with first and second wing panels 26 and 28 of each forming spaced legs 72. The other structural features of the scutoidal sub-cells, such as spine joints 10 extending between corner joint 44, base vertex 12, end joints 32 and 38, opposite and adjacent sides 4 and 6, as well as panels 14 and 16, are also shown herein. It is notable that spaced legs 72, formed by each of scutoidal sub-cells 2″ and 2′″, form a cell space 80 therebetween. It is appreciated that scutoidal panels 18 of scutoidal sub-cells 2 and 2′ are configured to mate or abut each other and fit into cell space 80 between spaced legs 72 of scutoidal sub-cells 2″ and 2′″.

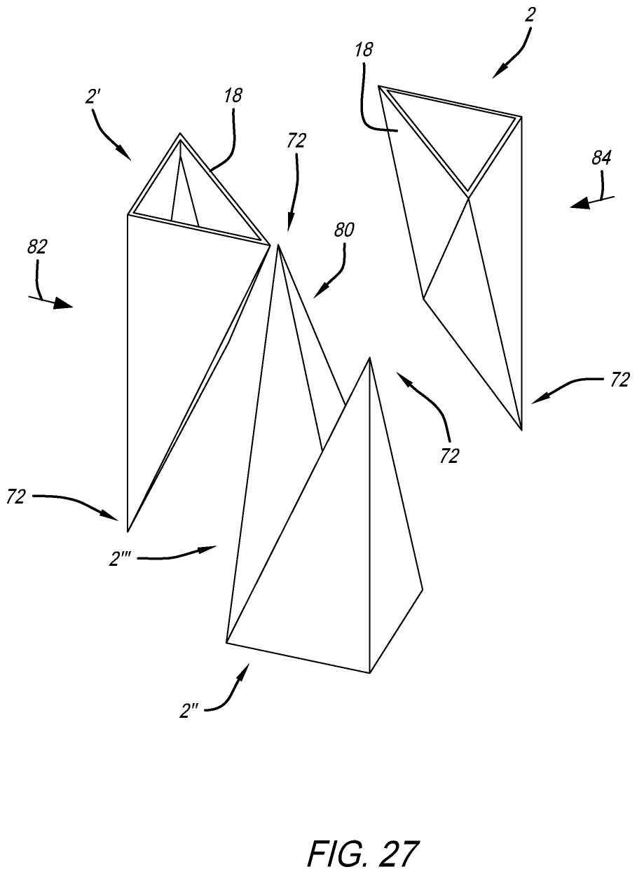

A perspective view shown in FIG. 27 includes scutoidal sub-cells 2 and 2′ moving closer in directions 84 and 82, respectively, toward cell space 80 located between spaced legs 72 of scutoidal sub-cells 2″ and 2′″. It will be appreciated that as scutoidal panels 18 of scutoidal sub-cells 2 and 2′ are brought together, they too will form spaced legs 72 that abut spaced legs 72 of scutoidal sub-cells 2″ and 2′″ to form scutoidal cell 70. Movement of scutoidal csub-ells 2 and 2′ toward each other are indicated by directional arrows 82 and 84.

A perspective view of scutoidal sub-cells 2, 2′, 2″, and 2′″ in further progression to form scutoidal cell 70, is shown in FIG. 28. Here, scutoidal sub-cells 2, and 2′ are moved further in directions 84 and 82, respectively, such that their respective scutoidal panels 18 abut or engage each other at this point. Spaced legs 72 are formed by scutoidal sub-cells 2 and 2′ forming its own cell space 80 sized to accommodate scutoidal sub-cells 2″ and 2′″. With movement of scutoidal sub-cells 2 and 2′ in direction 86 as shown, they fit in cell space 80 formed between spaced legs 72 of scutoidal sub-cells 2″ and 2′″.

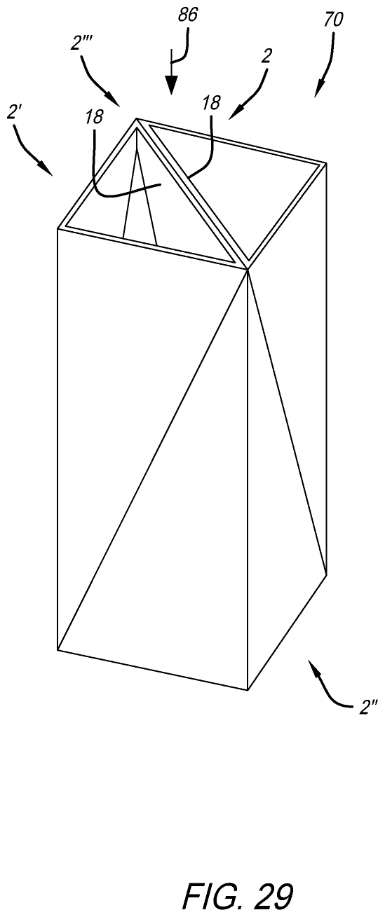

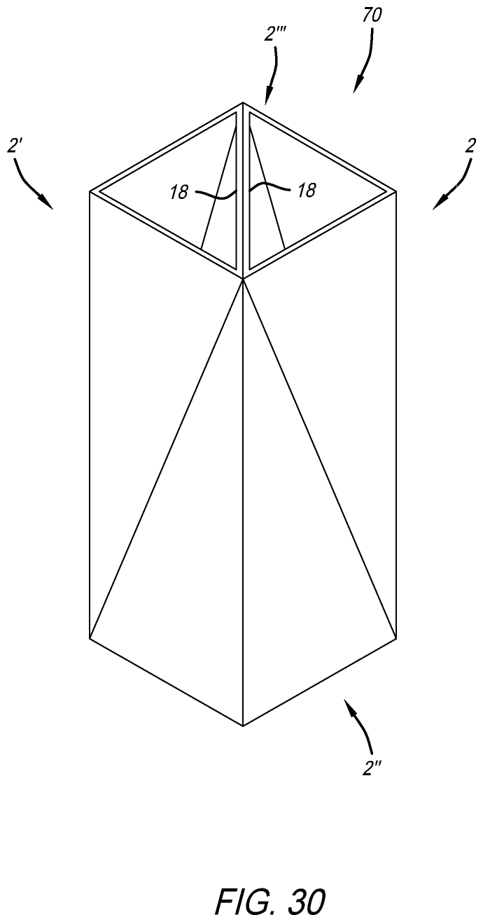

A perspective view of scutoidal cell 70 is shown in FIG. 29 that resulted by moving scutoidal sub-cells 2 and 2′ in direction 86 until they mated with scutoidal sub-cells 2″ and 2′″. Similarly with respect to the perspective view of scutoidal cell 70 in FIG. 30, it is rotated from that shown in FIG. 29, and is a similar view as that shown in FIG. 18.

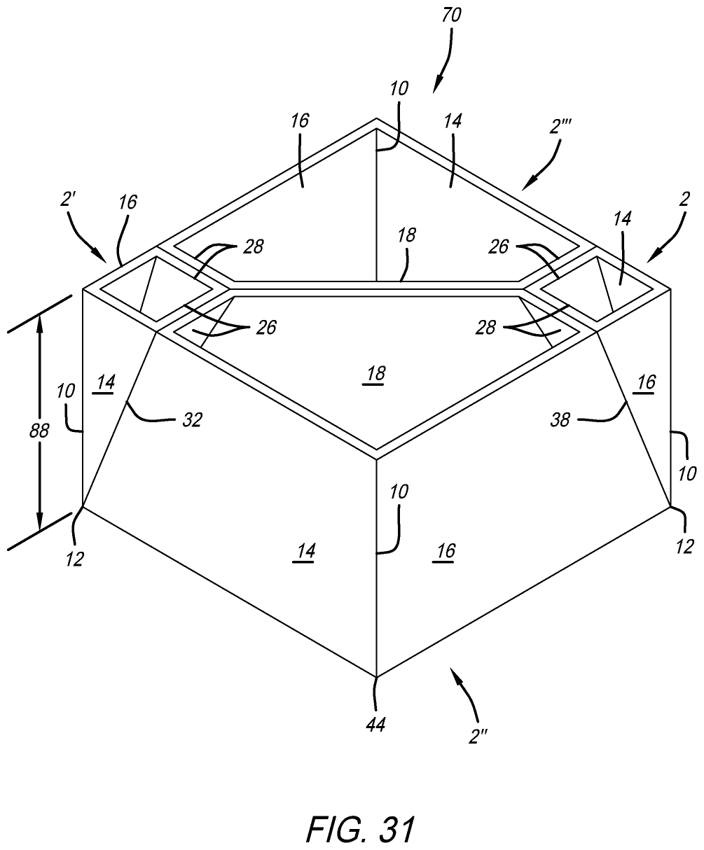

In order to create various and different geometric designs of scutoidal cell 70, it can be sliced transverse to height 54 of same at different locations along height 54. The cell geometry is antisymmetric with respect to the plane that lies at approximately or exactly 50% of the height of the cell. This can be seen by observing the cross-sections in planes that lie at the same distance above and below the plane of the half-height cross-section of the cell. For example, FIGS. 31 through 36 show scutoidal cell 70 sliced transverse to its height 54 at different locations such as approximately or exactly a quarter of the way up, half the way up, and approximately or exactly three quarters of the way up. These views demonstrate how different geometric designs are produced depending on where, along the height of scutoidal cell 70, it is sliced. It is appreciated that the slices along height 54 may be exact (e.g., quarter, half, three quarters) or approximate (any height outside quarter, half, or three quarters).

The perspective view of scutoidal cell 70 shown in FIG. 31 has been sliced at approximately or exactly one quarter the height of a full scutoidal cell 70 as indicated by reference number 88. In this condition, the geometric shape of scutoidal cell 70 is composed of scutoidal sub-cells 2, 2′, 2″, and 2′″ as shown. Scutoidal panels 18 from scutoidal sub-cells 2″ and 2′″ are shown abutting or mating each other and extending diagonally across scutoidal cell 70 until first and second wing panels 26 and 28, respectively, of each of scutoidal sub-cells 2″ and 2′″ abut corresponding first and second wing panels 26 and 28, respectively, of scutoidal sub-cells 2, and 2′ as shown. Opposite and adjacent panels 14 and 16 from all of scutoidal sub-cells 2, 2′, 2″, and 2′″ form the outer peripheral walls of this version of scutoidal cell 70. End joints 32 and 38 also form seams at the periphery of scutoidal cell 70 as shown.

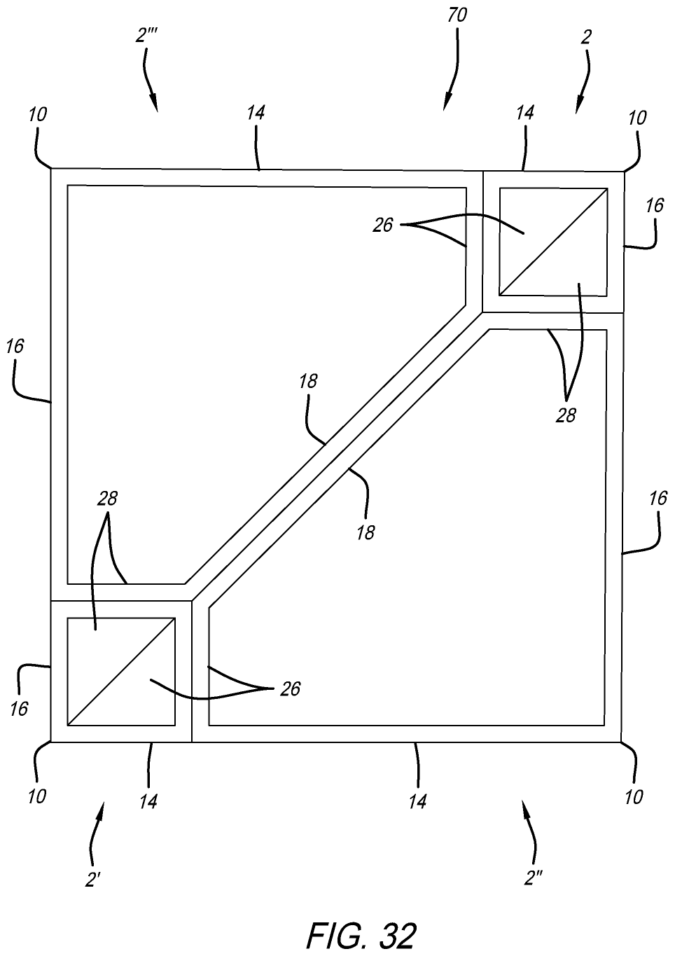

A top view of scutoidal cell 70, cut at approximately or exactly quarter height 88, from FIG. 31, is shown in FIG. 32. This view shows the outer periphery of scutoidal cell 70 formed by opposite and adjacent panels 14 and 16, respectively, with abutting scutoidal panels 18 of scutoidal sub-cells 2″ and 2′″ extending diagonally within the cell. This view also shows how first and second wing panels 26 and 28 abut each other to form the geometry shown. Because the three internal diagonal panels 26 and 28 of each sub-cell are neither parallel to plane 52 nor perpendicular to it, and the diagonal scutoidal panel 18 is inclined by approximately or exactly 45 degrees with respect to each of the panels 14 and 16, compressive strength along multiple directions, including lateral and axial is believed to increase.

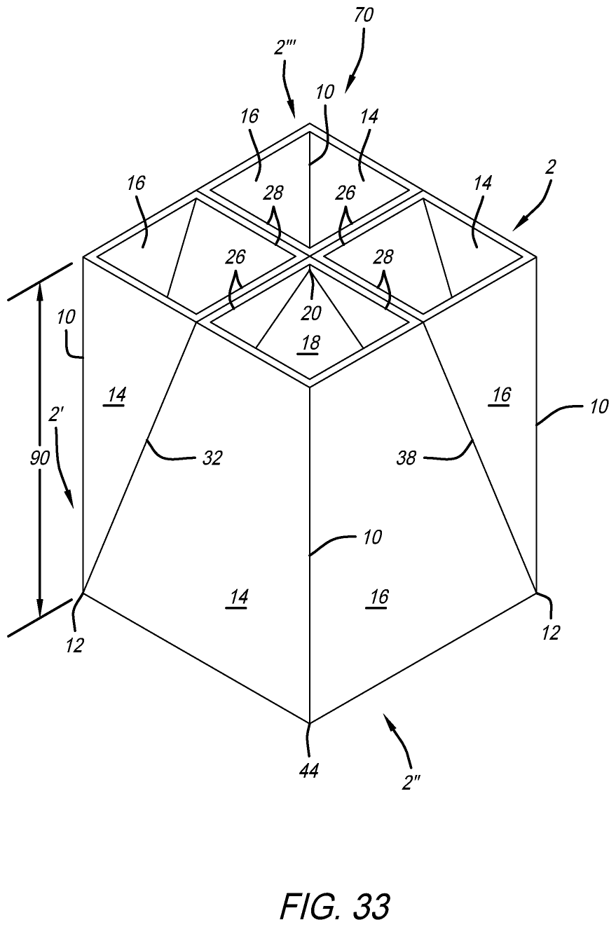

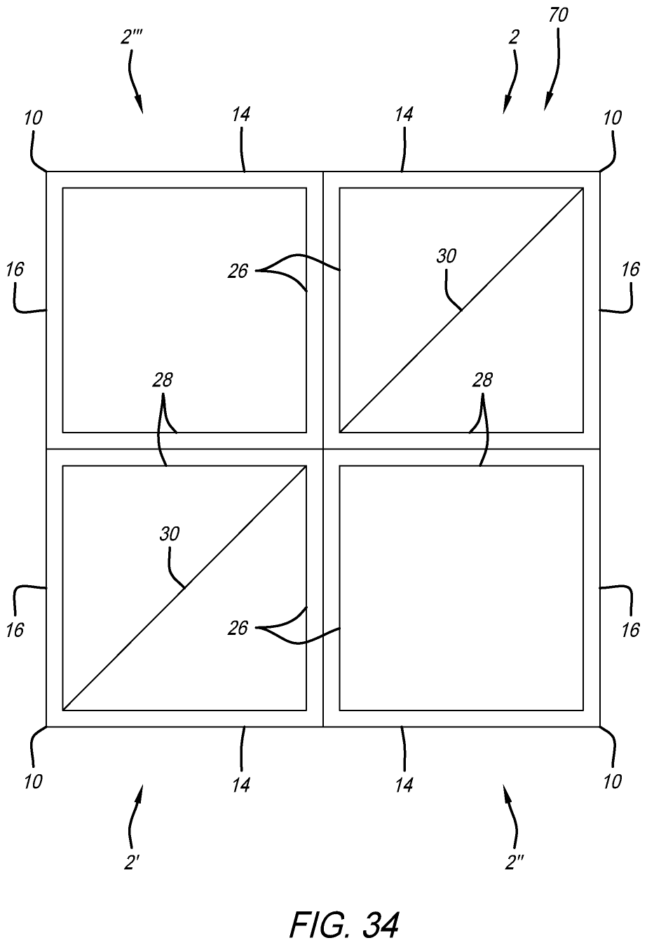

Perspective and top views of scutoidal cell 70 are shown in FIGS. 33 and 34, respectively. A distinction between these views of scutoidal cell 70 in FIGS. 33 and 34 and scutoidal cell 70 in FIGS. 31 and 32, are that here scutoidal cell 70 was sliced approximately or exactly half way up height 54 as indicated by reference number 90. The resulting geometric structure, however, is very much different than the geometric structure of scutoidal cell 70 in FIGS. 31 and 32, despite being the same cells. Again, a distinction being the location along the height of the cell where it is cut. The outer periphery as shown above in FIGS. 33 and 34 are composed the same as that shown in FIGS. 31 and 32. Particularly, panels 14 and 16 with joints 32 and 38, as shown therein, form the outer wall of scutoidal cell 70. The cross shape shown is created by first and second wing panels 26 and 28 from all of scutoidal sub-cells 2, 2′, 2″, and 2″ abutting each other in the manner shown. Additionally, the cut at about half-height 90 is made at about scutoidal vertex 20 of all of scutoidal sub-cells 2, 2′, 2″, and 2″. It is at about this location that all of the first and second wing panels intersect to form the cross-type interior geometry as shown. Furthermore, with first and second wing panels 26 and 28 being a larger portion of the interior geometry of scutoidal cell 70, there are more angled structures that are neither perpendicular nor parallel to the exterior walls. Because the three internal diagonal panels 26 and 28 of each sub-cell are neither parallel to plane 52 nor perpendicular to it, and diagonal panel 18 is inclined by approximately or exactly 45 degrees with respect to each of the panels 14 and 16, compressive strength along multiple directions, including lateral and axial is believed to increase. The top view shown in FIG. 34 also depicts wing spine joints of scutoidal sub-cells 2, and 2′ formed by first and second wing panels 26 and 28.

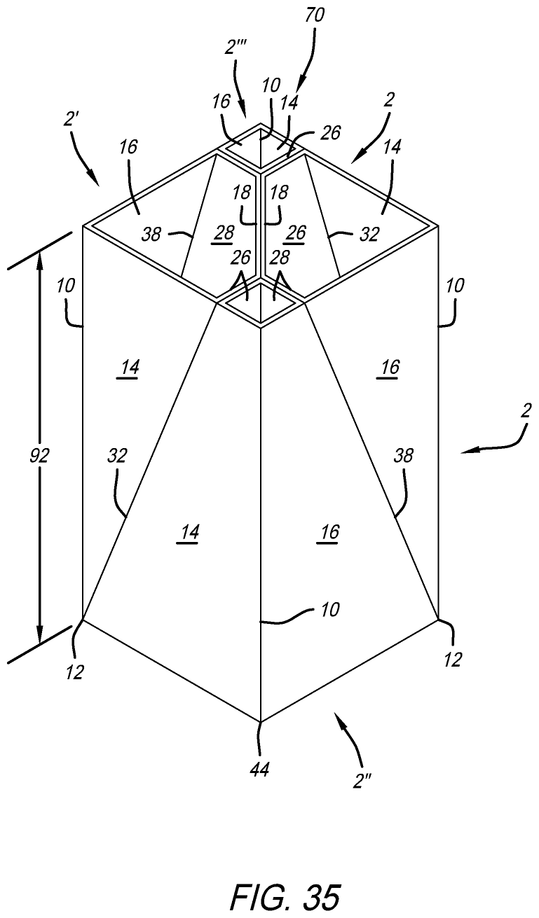

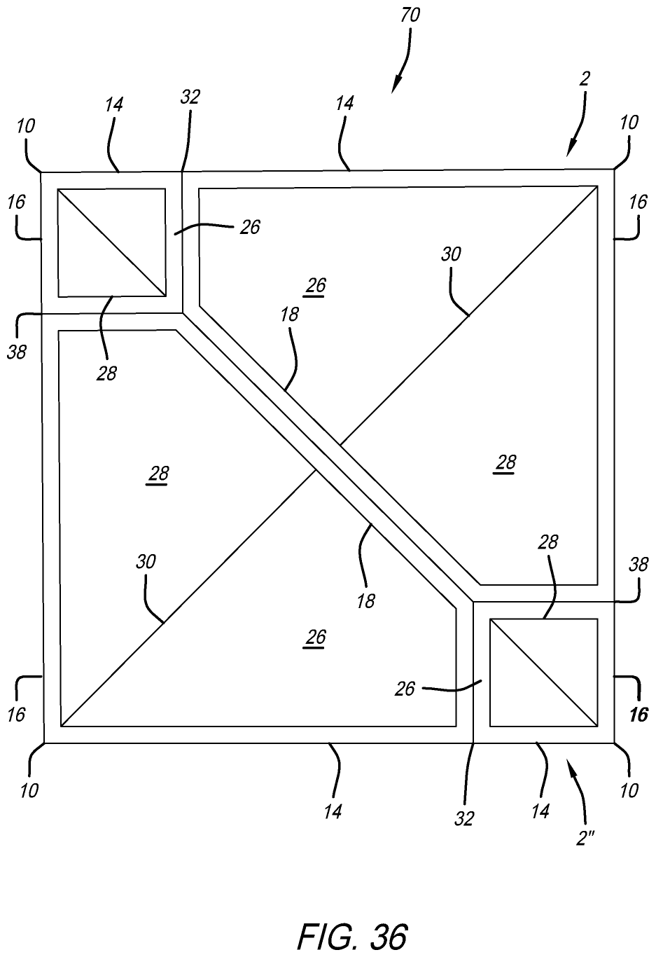

Perspective and top views of scutoidal cell 70 are shown in FIGS. 35 and 36. These views differ from those of FIGS. 31 through 33 in that here scutoidal cell 70 has been sliced at approximately or exactly three quarters the way up of height 54 as indicated by reference 92. This results in a different interior geometry from that of scutoidal cell 70 in prior FIGS. 31 through 34. Now, scutoidal panels 18 of scutoidal sub-cells 2 and 2′ are shown extending diagonally within the cell. It is also appreciated that scutoidal panels 18 of scutoidal sub-cells 2″ and 2′″ will be extending diagonally in the lower portion of scutoidal cell 70 transverse to scutoidal panels 18 shown here of scutoidal sub-cells 2 and 2′. Like the other embodiments, however, the outer periphery of scutoidal cell 70 is still composed of opposite and adjacent panels 14 and 16 along with spine joints 10 forming the corners of scutoidal cell 70. Also shown forming a portion of the interior geometry are first and second wing panels of scutoidal sub-cells 2, 2′, 2″, and 2″.

In the top view of scutoidal 70 of FIG. 36, wing spine joint 30 is also visible extending between first and second wing panels 26 and 28. Because the three internal diagonal panel 26 and 28 of each sub-cell are neither parallel to plane 52 nor perpendicular to it, and the diagonal panel 18 is inclined by approximately or exactly 45 degrees with respect to each of the panels 14 and 16, the compressive strength along multiple directions, including lateral and axial is believed to increase.

It will be appreciated by the skilled artisan upon reading this disclosure that by using a full height 54 scutoidal cell 70 or a partial height scutoidal cell 70—whether quarter, half, three quarter, or any range in between height—as well as repeating those scutoidal cells 70 in similar or different orientations in a panel may provide enhanced compressive force resistance characteristics for the panel itself.

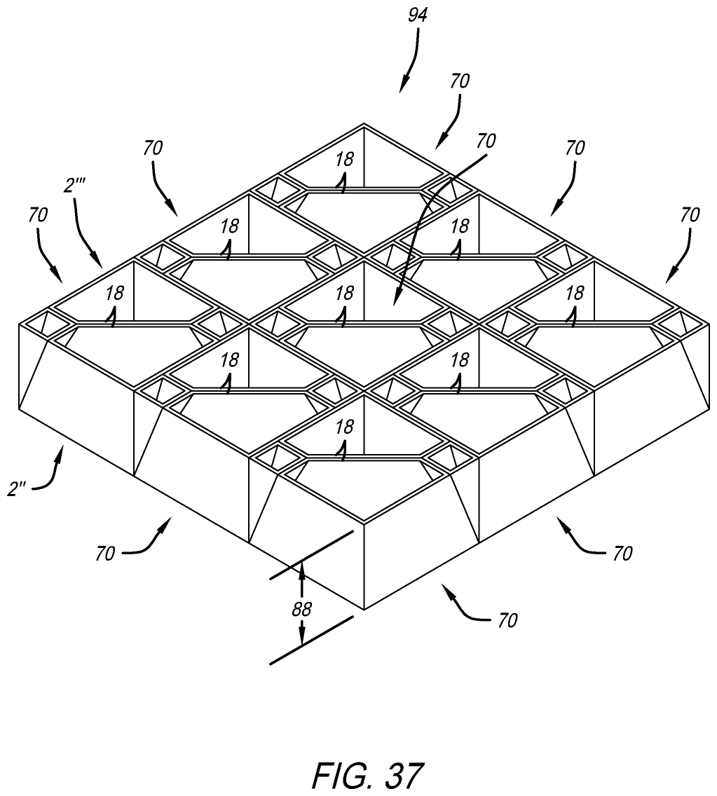

As shown in FIGS. 37 through 52, a variety of panels with unique interior geometry for each cell may be employed. For example, with respect to the perspective and top views of panel 94, a plurality of scutoidal cells 70 are horizontally aligned in a panel form of repeating cells. This particular panel 94 is composed of repeating scutoidal cell 70 that have been cut approximately or exactly a quarter height 88 like that shown in FIG. 31. A characteristic of panel 94 is that all of scutoidal cells 70 are oriented in the same manner. In other words, as shown here, scutoidal panels 18 from scutoidal sub-cells 2″ and 2′″ from each of scutoidal cells 70 are oriented in the same direction. The panel configuration with all the cells having the same orientation might be one of the possible design solutions that might be chosen according to the expected or anticipated loads.

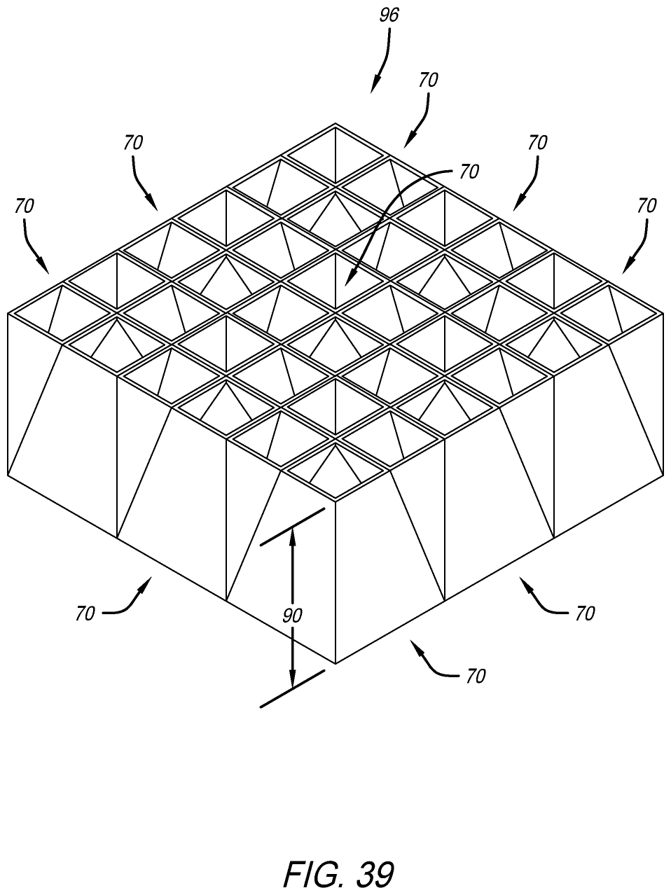

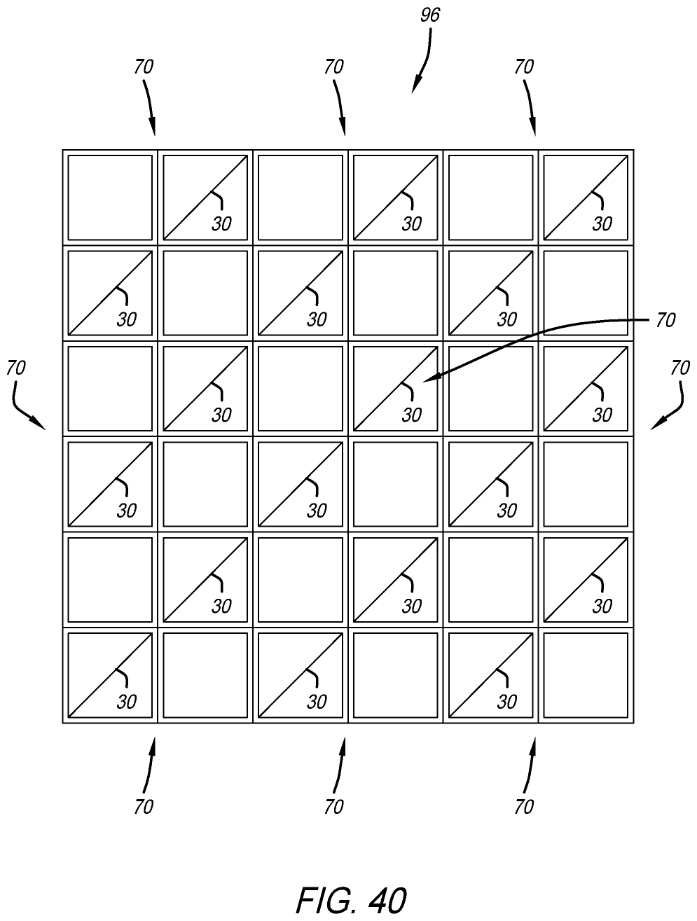

Perspective and top views of panel 96 are shown in FIGS. 39 and 40, respectively. In contrast to panel 94, panel 96 is composed of repeating scutoidal cell 70, but cut at approximately or exactly half-height 90 as demonstrated in the perspective and top views of scutoidal cell 70 of FIGS. 33 and 34. Like in those views, first and second wing panels 26 and 28, respectively, form a cross design intersecting at about scutoidal vertex 20. The internal diagonal panels inside scutoidal cell 70 provide additional stiffness and energy absorption under lateral loads, thanks to the load paths that they provide for lateral loads. Because the three internal diagonal panel 26 and 28 of each sub-cell are neither parallel to plane 52 nor perpendicular to it, and the diagonal panel 18 is inclined by approximately or exactly 45 degrees with respect to each of the panels 14 and 16, the compressive strength along multiple directions, including lateral and axial is believed to increase. The panel configuration with all the cells having the same orientation might be one of the possible design solutions that might be chosen according to expected or anticipated loads.

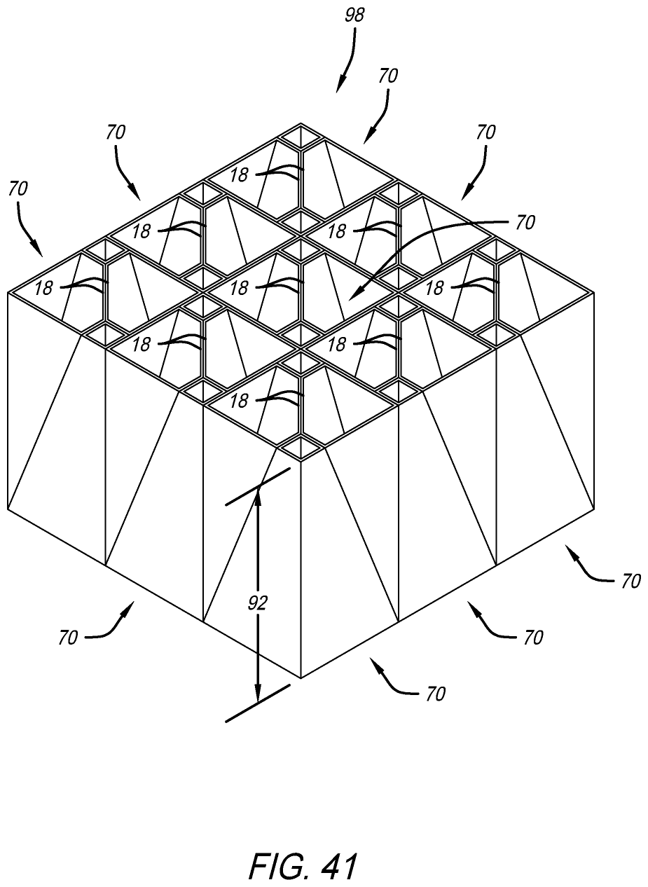

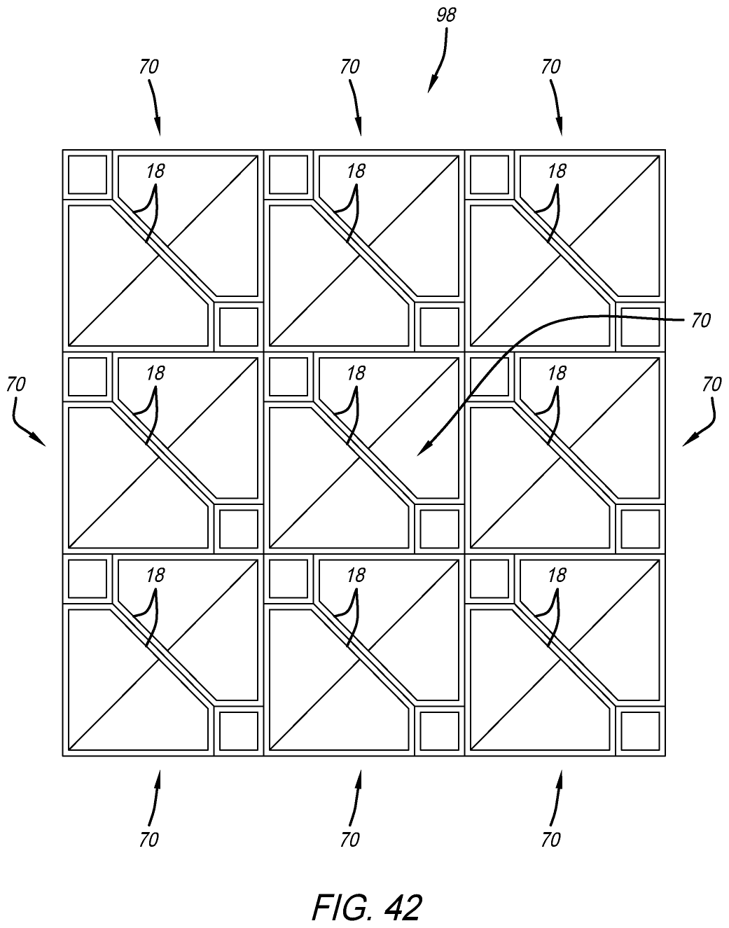

Perspective and top views of panel 98 are shown in FIGS. 41 and 42, respectively. In contrast to panels 94 and 96, panel 98 is composed of repeating scutoidal cell 70, but cut at approximately or exactly three quarters height as demonstrated in the perspective and top views of scutoidal cell 70 in FIGS. 35 and 36. Like in those views, the double scutoidal panels 18 are included in this configuration. The internal diagonal panels inside scutoidal cell 70 provide additional stiffness and energy absorption under lateral loads, thanks to the load paths that they provide for lateral loads. Because the three internal diagonal panels 26 and 28 of each sub-cell are neither parallel to plane 52 nor perpendicular to it, and the diagonal panel 18 is inclined by approximately or exactly 45 degrees with respect to each of the panels 14 and 16, the compressive strength along multiple directions, including lateral and axial is believed to increase. The panel configuration with all the cells having the same orientation might be one of the possible design solutions that might be chosen according to expected or anticipated loads.

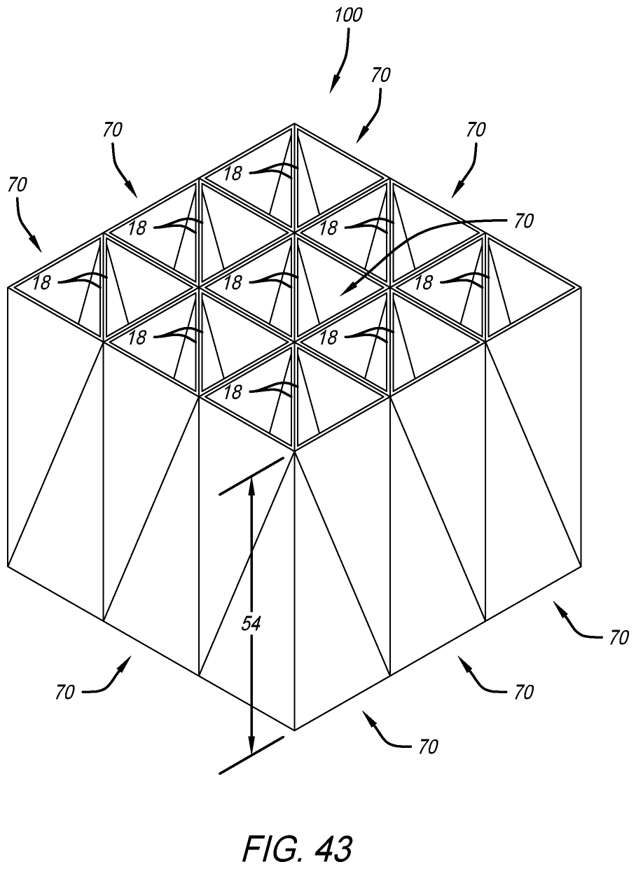

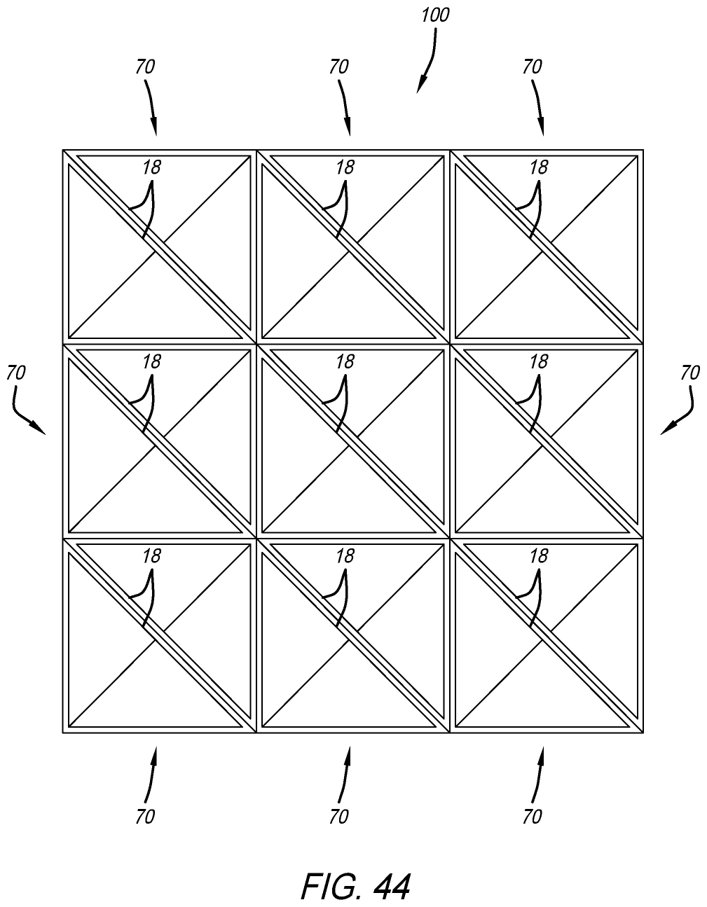

Perspective and top views of panel 100 is shown in FIGS. 43 and 44, respectively. These views depict a full height 54 embodiment of scutoidal cell 70. In the illustrated embodiment, it is notable that all of the scutoidal panels 18 from each scutoidal cell 70 are oriented in the same direction. The internal diagonal panels inside scutoidal cell 70 provide additional stiffness and energy absorption under lateral loads, thanks to the load paths that they provide for lateral loads. Because the three internal diagonal panels 26 and 28 of each sub-cell are neither parallel to plane 52 nor perpendicular to it, and the diagonal panel 18 is inclined by approximately or exactly 45 degrees with respect to each of the panels 14 and 16, compressive strength along multiple directions, including lateral and axial is believed to increase. The panel configuration with all the cells having the same orientation might be one of the possible design solutions that might be chosen according to expected or anticipated loads.

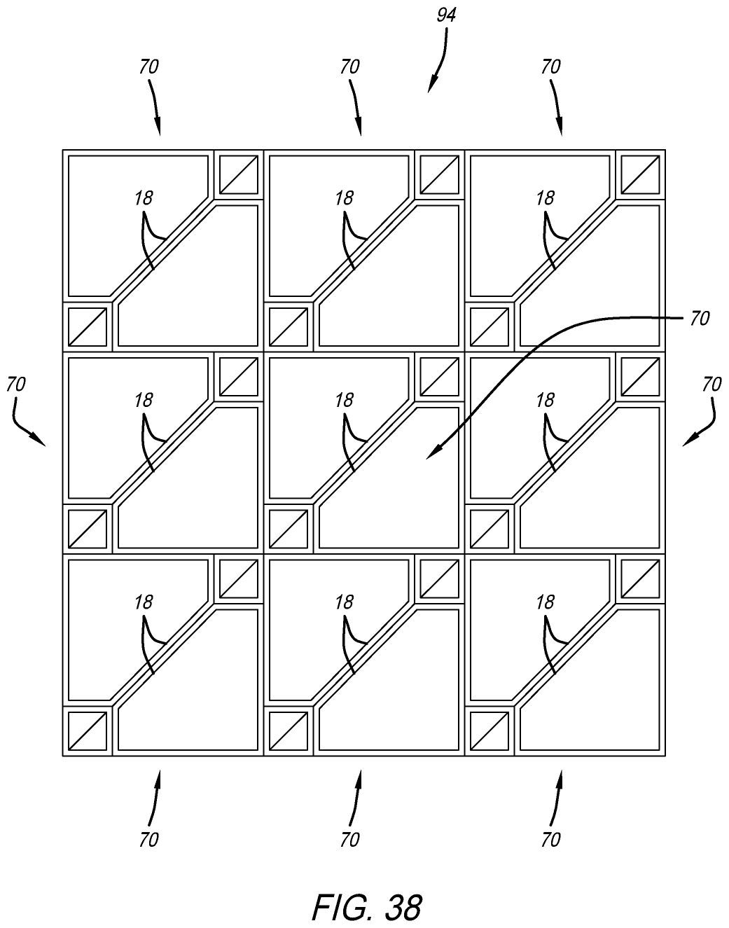

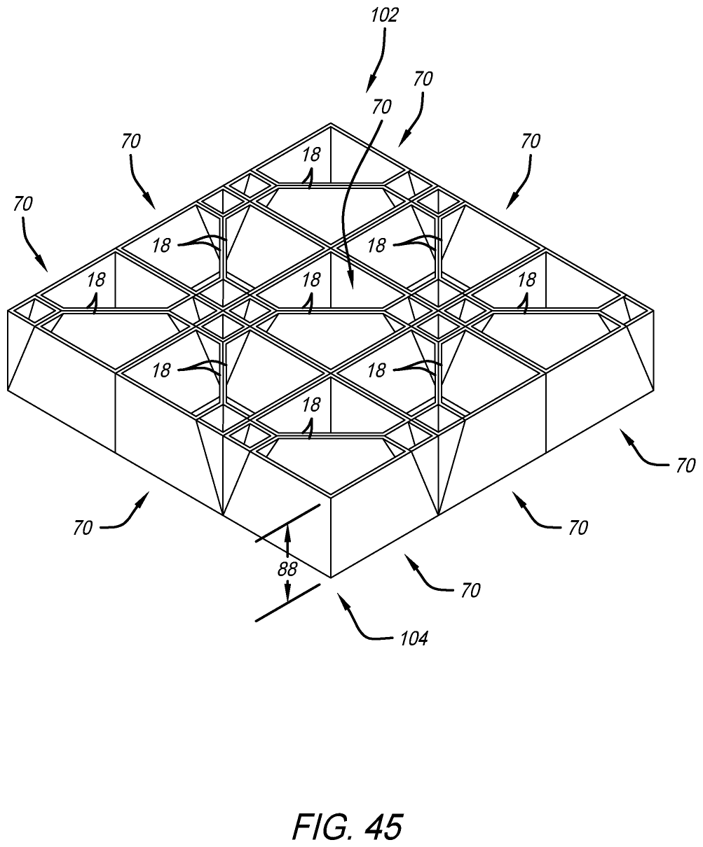

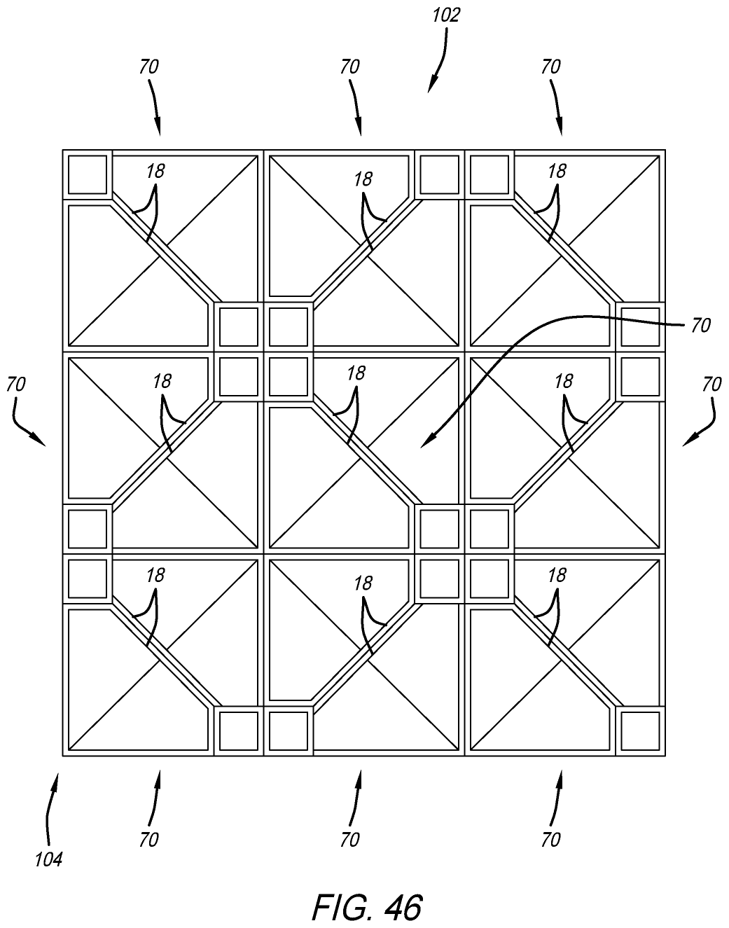

The perspective and top views shown in FIGS. 45 through 52 depict scutoidal cell 70 cut at different heights of the cell, as well as being arranged in different patterns to form the panel. For example, in FIGS. 45 and 46, panel 102 is composed of scutoidal cells 70 cut at quarter height 88 like that discussed in FIGS. 31, 32, 37, and 38. In contrast to panel 94 disclosed in FIGS. 37 and 38, scutoidal cell 70 in FIGS. 45 and 46 are oriented at different angles. For instance, scutoidal cell 70 located at illustrative corner 104 is oriented so scutoidal panels 18 are oriented in a first direction. Its adjacent scutoidal cell 70, as shown, is oriented so its scutoidal panels 18 are oriented in an opposing direction. As shown in these views, the orientations of scutoidal cell 70 can be oriented differently to create different patterns. The panel configuration with the cells having two different orientations, with every other cell having the same orientation (with a chessboard-like distribution), might be a possible design solution that might be chosen according to anticipated or expected lateral loads.

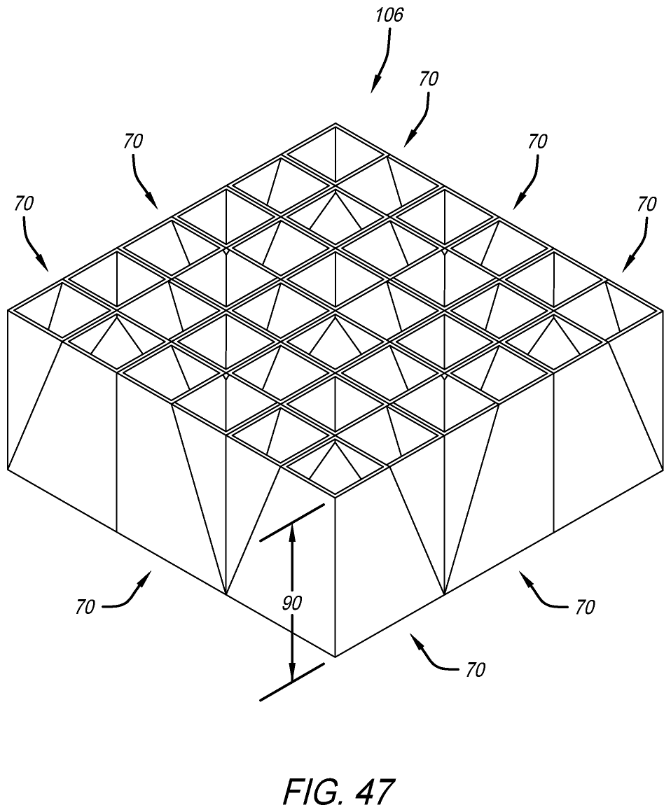

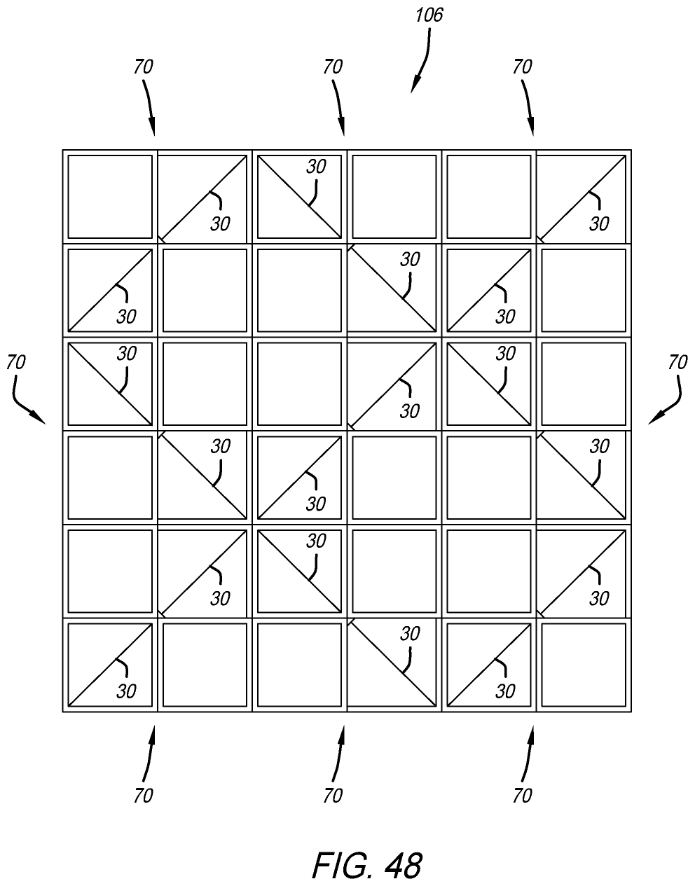

Perspective and top views of panel 106 are shown in FIGS. 47 and 48 similar to the half-height 90 of scutoidal cell 70 shown in FIGS. 33, 34, 39, and 40. In contrast to panel 96 disclosed in FIGS. 39 and 40, the several scutoidal cells 70 herein are oriented at different orientations. This is evident by the positioning of wing spine joint 30 in panel 106 compared to panel 96. As shown in these views, the orientations of scutoidal cell 70 can be oriented differently to create a different pattern. The panel configuration with the cells having two different orientations, with every other cell having the same orientation (with a chessboard-like distribution), might be a possible design solution that might be chosen according to anticipated or expected lateral loads.

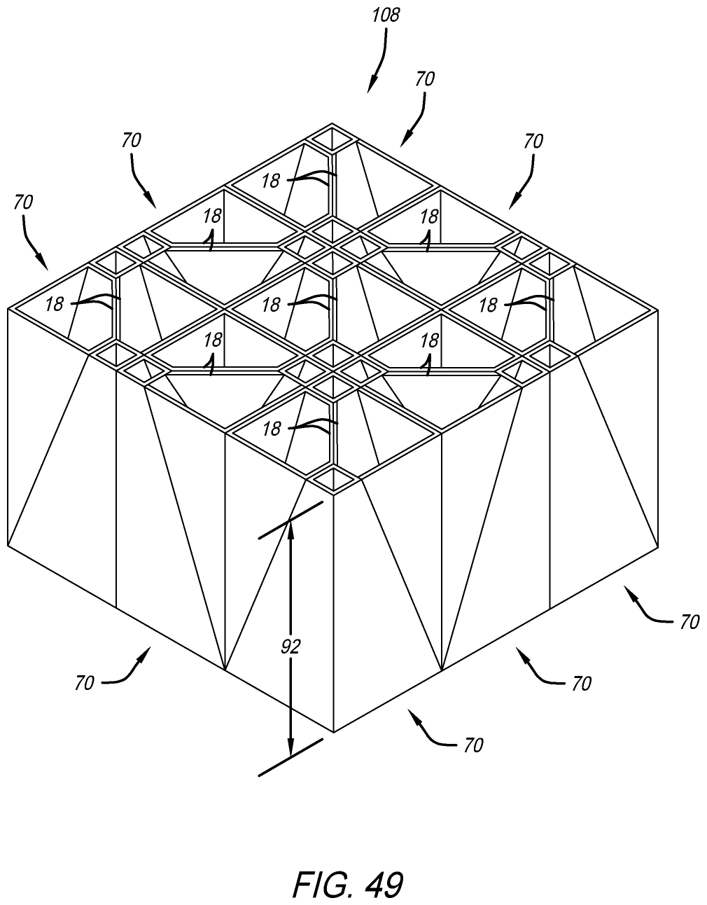

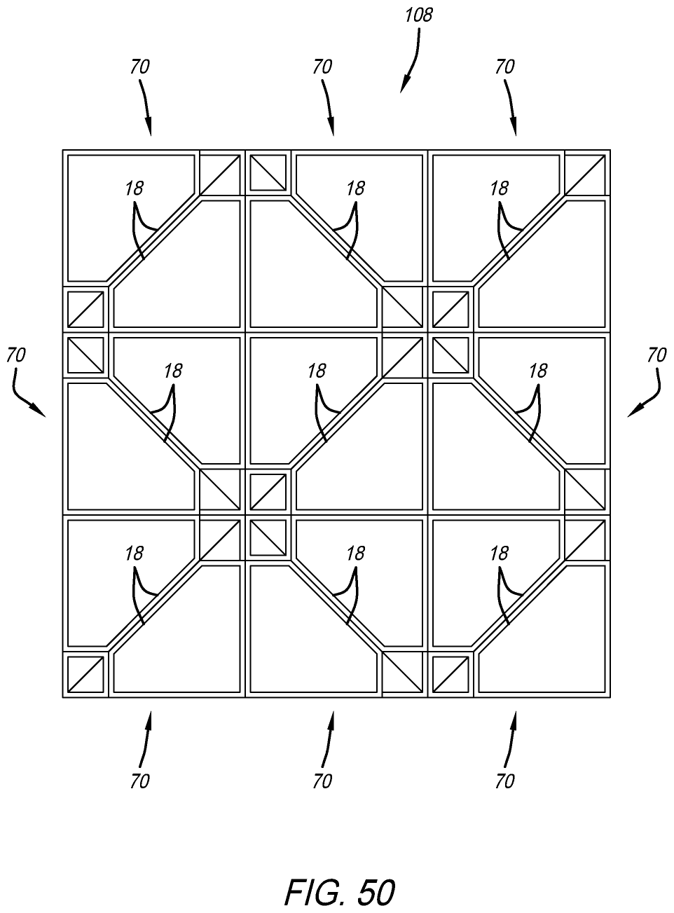

Perspective and top views of panel 108 are shown in FIGS. 49 and 50 similar to the three quarters height 92 of scutoidal cell 70 shown in FIGS. 35, 36, 41, and 42. In contrast to panel 98 disclosed in FIGS. 41 and 42, however, several scutoidal cells 70 herein are oriented at different orientations. This is evident by the positioning of abutting scutoidal panels 18 in panel 108 compared to panel 98. As shown in these views, the orientations of scutoidal cell 70 can be oriented differently to create a different pattern. The panel configuration with the cells having two different orientations, with every other cell having the same orientation (with a chessboard-like distribution), might be a possible design solutions that might be chosen according to anticipated or expected lateral loads.

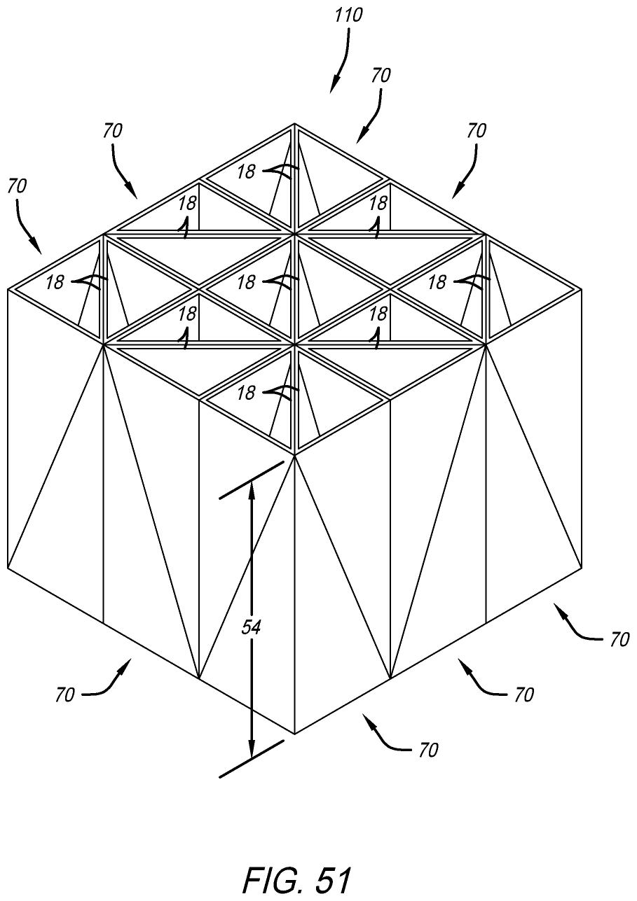

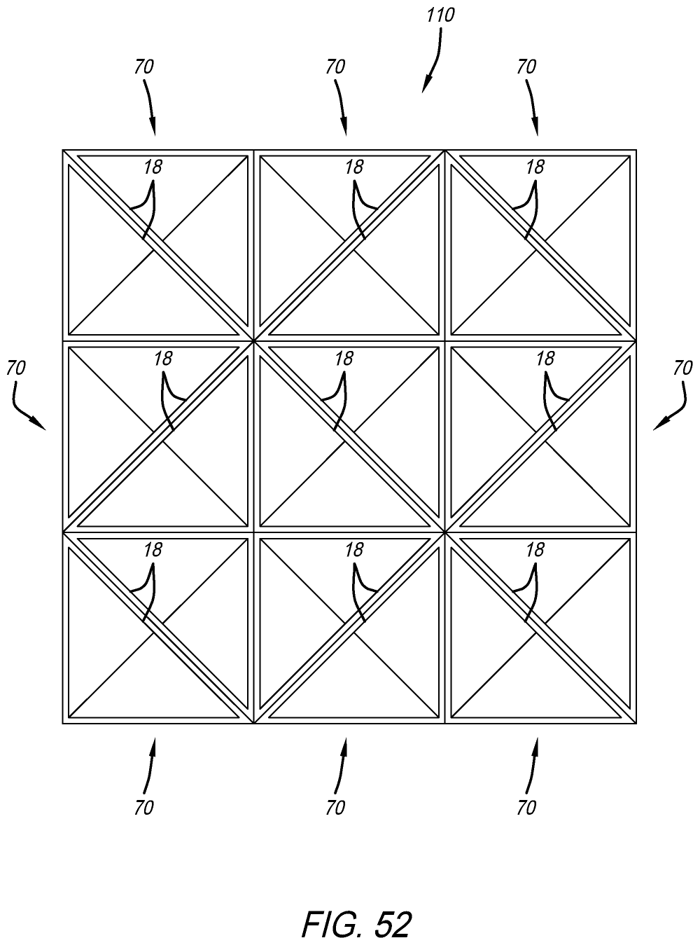

Perspective and top views of panel 110 are shown in FIGS. 51 and 52 similar to the full height 54 of scutoidal cell 70 shown in FIGS. 43 and 44. In contrast to panel 100 disclosed in FIGS. 43 and 44, however, several scutoidal cell 70 herein are oriented at different orientations. This is evident by the positioning of abutting scutoidal panels 18 in panel 110 compared to panel 100. As shown in these views, the orientations of scutoidal cell 70 can be oriented differently to create a different pattern. The panel configuration with the cells having two different orientations, with every other cell having the same orientation (with a chessboard-like distribution), might be a possible design solutions that might be chosen according to anticipated or expected lateral loads.

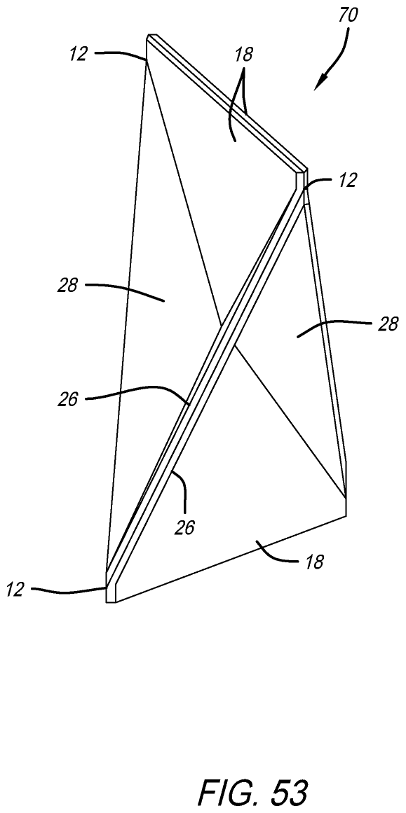

A perspective view of the interior of a scutoidal cell 70 are shown in FIG. 53. Here, the internal geometry of scutoidal cell 70 can be appreciated. The several abutting scutoidal panels 18 are visible with a top set shown approximately or exactly perpendicular to a bottom set. First and second wing panels 26 and 28, respectively, from the various sub cells are shown abutting each other as well. The geometry shown in FIG. 53 constitutes the internal structure that is enclosed within four vertical walls (not shown in FIG. 53). Such internal structure, thanks to the inclination of the walls with respect to the external vertical walls and with respect to the horizontal planes 52, may provide additional load paths for the lateral loads, thus increasing the energy absorption capabilities under lateral loads. The internal diagonal walls, that also have a component parallel to the cell height 54, are believed to contribute to maintain a high level of energy absorption along the axial direction. As a result, it is believed that the proposed cell geometry allows it to increase the energy absorption under lateral loads, while providing the same level of energy absorption under axial loads, if compared to a standard hexagonal cell with the same mass and height, and constituted by the same material.

Corresponding reference characters indicate corresponding parts throughout the several views. Although the present disclosure has been described with reference to particular means, materials and embodiments, from the foregoing description, one skilled in the art can easily ascertain the essential characteristics of the disclosure and various changes and modifications may be made to adapt the various uses and characteristics without departing from the spirit and scope of the disclosure.

1. A cell comprising:
a sub-cell that is longitudinally extending along an axis and is composed of at least:
a longitudinally extending first panel;
wherein the first panel includes a longitudinally extending first edge and a longitudinally extending second edge;
a longitudinally extending second panel;
wherein the second panel includes a longitudinally extending first edge and a longitudinally extending second edge;
wherein the second edge of the first panel abuts the first edge of the second panel at a first angle to form a longitudinally extending first joint between the first panel and the second panel;
a longitudinally extending third panel extends between the first panel and the second panel which forms a periphery of an open space between the first panel, the second panel, and the third panel;
wherein the third panel is triangularly-shaped and includes a longitudinally extending first edge and a longitudinally extending second edge both of which terminate and join at a first vertex;
a fourth panel bounded by at least a longitudinally extending first edge, a longitudinally extending second edge, and a longitudinally extending third edge;
wherein the first edge of the fourth panel abuts the first edge of the first panel forming a longitudinally extending second joint;
wherein the second edge of the fourth panel abuts the first edge of the third panel to form a longitudinally extending third joint; and
a fifth panel bounded by at least a longitudinally extending first edge, a longitudinally extending second edge, and a longitudinally extending third edge;
wherein the third edge of the fourth panel abuts the first edge of the fifth panel to form a longitudinally extending fourth joint;
wherein a first end of the fourth joint terminates at the first vertex;
wherein the second edge of the fifth panel abuts the second edge of the third panel to form a longitudinally extending fifth joint;
wherein the third edge of the fifth panel abuts the second edge of the second panel to form a longitudinally extending sixth joint; and
wherein a first end of the second joint, a second end of the fourth joint, and a first end of the sixth joint terminate and join at a second vertex.

2. The cell of claim 1, wherein the first panel includes a top edge, the second panel includes a top edge, and the third panel includes a top edge.

3. The cell of claim 2, wherein the top edge of the first panel, the top edge of the second panel, and the top edge of the third panel, form a triangular shape oriented transverse to the axis and forms a periphery of an opening of the open space.

4. The cell of claim 3, wherein a distal end of the sub-cell opposite the opening is the second vertex.

5. The cell of claim 1, wherein the first angle between the first panel in the second panel is about a 90° angle.

6. The cell of claim 1, wherein the third panel has a planar surface that is longitudinally extending parallel to the first joint.

7. The cell of claim 1, wherein a top edge of the first panel, a top edge of the second panel, a top edge of the third panel, a top edge of the fourth panel, and the top edge of the fifth panel form an octagon shape oriented transverse to the axis and forms a periphery of an opening of the open space.

8. The cell of claim 1, further comprising a half cell formed of a planar surface of the third panel of the sub-cell and a planar surface of a third panel of a second sub-cell which abut each other to form a quadrilateral polygon outer shape transverse to the axis at a top end and the second vertex of the sub-cell is spaced apart from a second vertex of the second sub-cell at an end distal from a top end of the second sub-cell.

9. The cell of claim 8, further comprising a second half cell oriented opposite the half cell and is positioned so the second vertex of the sub-cell spaced apart from the second vertex of the second sub-cell of the second half cell are both located adjacent the half cell to form a cell which has a quadrilateral polygon outer shape transverse to the axis along a longitudinal extent of the cell.

10. The cell of claim 9, wherein the second half cell is identically shaped to the half cell.

11. The cell of claim 1, wherein the first panel has a longitudinally extending planar surface, the second panel has a longitudinally extending planar surface, the third panel has a longitudinally extending planar surface, the fourth panel has a longitudinally extending planar surface, and the fifth panel has a longitudinally extending planar surface, wherein none of these planar surfaces are parallel to each other along a longitudinal extent of the sub-cell.

12. The cell of claim 9, wherein a plurality of cells are connected to each other to form a panel.

13. The cell of claim 9, wherein the cell is cut transverse to the longitudinal extent such that an end profile is formed that is composed of opposing pentagonal peripheries from the half cell and opposing quadrilateral peripheries from the second half cell.

14. A cell comprising:
a sub-cell that is longitudinally extending along an axis and is composed of at least:
a longitudinally extending first panel;
wherein the first panel includes a longitudinally extending first edge and a longitudinally extending second edge;
a longitudinally extending second panel;
wherein the second panel includes a longitudinally extending first edge and a longitudinally extending second edge;
wherein the second edge of the first panel abuts the first edge of the second panel at a first angle to form a longitudinally extending first joint between the first panel and the second panel;
a longitudinally extending third panel extends between the first panel and the second panel which forms a periphery of an open space between the first panel, the second panel, and the third panel;
wherein the third panel is triangularly-shaped and includes a longitudinally extending first edge and a longitudinally extending second edge both of which terminate and join at a first vertex;
a fourth panel bounded by at least a longitudinally extending first edge, a longitudinally extending second edge, and a longitudinally extending third edge;
wherein the first edge of the fourth panel abuts the first edge of the first panel forming a longitudinally extending second joint;
wherein the second edge of the fourth panel abuts the first edge of the third panel to form a longitudinally extending third joint; and
a fifth panel bounded by at least a longitudinally extending first edge, a longitudinally extending second edge, and a longitudinally extending third edge;
wherein the third edge of the fourth panel abuts the first edge of the fifth panel to form a longitudinally extending fourth joint;
wherein a first end of the fourth joint terminates at the first vertex;
wherein the second edge of the fifth panel abuts the second edge of the third panel to form a longitudinally extending fifth joint; and
wherein the third edge of the fifth panel abuts the second edge of the second panel to form a longitudinally extending sixth joint.

15. The cell of claim 14, wherein a first end of the second joint, a second end of the fourth joint, and a first end of the sixth joint terminate and join at a second vertex.

16. The cell of claim 15, further comprising a half cell formed of a planar surface of the third panel of the sub-cell and a planar surface of a third panel of a second sub-cell abut each other to form a quadrilateral polygon outer shape transverse to the axis at a top end.

17. The cell of claim 16, further comprising a second half cell oriented opposite the half cell and is positioned so the second vertex of the sub-cell spaced apart from the second vertex of the second sub-cell of the second half cell are both located adjacent the half cell to form a cell which has a quadrilateral polygon outer shape transverse to the axis along a longitudinal extent of the cell.

18. The cell of claim 17, wherein a plurality of cells are connected to each other to form a panel.

19. The cell of claim 17, wherein the cell is cut transverse to the longitudinal extent such that an end profile is formed that is composed of opposing pentagonal peripheries from the half cell and opposing quadrilateral peripheries from the second half cell.
